(19) United States
(12) Patent Application Publication
(10) Pub. No.: US 2024/0240951 A1
(43) Pub. Date: Jul. 18, 2024

(54) PATH PLANNING APPARATUS

(71) Applicant: Mitsubishi Electric Corporation, Tokyo (JP)

(72) Inventors: Yuki YOSHIDA, Tokyo (JP); Shota KAMEOKA, Tokyo (JP); Rin ITO, Tokyo (JP); Hiroaki KITANO, Tokyo (JP); Kenta TOMINAGA, Tokyo (JP)

(73) Assignee: Mitsubishi Electric Corporation, Tokyo (JP)

(21) Appl. No.: 18/562,324

(22) PCT Filed: May 24, 2021
(86) PCT No.: PCT/JP2021/019503

§ 371 Date: Nov. 19, 2023

(51) Int. Cl. G01C 21/34; B60W 60/00

(52) U.S. Cl. CPC G01C 21/3461; B60W 60/001; B60W 2520/10; B60W 2554/20; B60W 2554/4042; B60W 2554/4044

(57) ABSTRACT

The present disclosure relates to a path planning apparatus, and includes: a travelable region calculation unit configured to calculate a travelable region of a moving body, based on surrounding information of the moving body; a target state calculation unit configured to calculate target state quantity including at least a target position of the moving body; a state prediction unit configured to predict at least current state quantity of the moving body and state quantity of the moving body at one or more positions between a current position and the target position of the moving body, and thereby generate one or more path candidates; a predicted state evaluation unit configured to evaluate the one or more path candidates based on the target state quantity and the travelable region, and output evaluation results; and a path generation unit configured to generate a path from the one or more path candidates based on the evaluation results, and output the path to a motion controller configured to control the moving body based on the path.

### TECHNICAL FIELD

The present disclosure relates to a path planning apparatus, and more particularly relates to a path planning apparatus that plans an operation for implementing automated driving of a vehicle or the like.

### BACKGROUND ART

In recent years, automated driving of an automobile and an autonomous moving system of a conveyance carriage or the like have been developed. In the autonomous moving system, a path including a track to be traveled by a moving body and a speed is generated, and control is performed so that the moving body travels along the generated path. Regarding path planning, in many scenes, path planning along the center of a road and an inductor such as a magnetic marker is performed. However, depending on a case, in a scene of traveling near a toll booth with no white lines on a road or on an unpaved road and a scene in which an autonomous conveyance carriage with no use of an inductor moves to a destination, such information cannot be used. In such scenes, a path that enables reaching the destination while avoiding an obstruction in a space where there is no information of a marker to be traveled on is required. For example, as disclosed in Patent Document 1, a technology has been developed in which path planning is implemented even when there is no information of a marker to be traveled on.

### PRIOR ART DOCUMENT

### Patent Document

Patent Document 1: Japanese Patent Application Laid-Open No. 2012-145998

### SUMMARY

### Problem to be Solved by the Invention

Patent Document 1 employs a method of generating a traveling route, based on a direction along a road including a line passing through center points of a plurality of circles inscribed in a travelable region with no obstructions. In this case, for example, inscribed circles cannot be determined in a significantly wide travelable region such as an airport, and thus a traveling route cannot be generated and a destination cannot be reached. Further, in a travelable region having a complicated shape and having great changes in the width, such as near a toll booth, a correct direction along a road cannot be calculated and a destination cannot be reached.

The present disclosure is made in order to solve the problems as described above, and has an object to provide a path planning apparatus that enables reaching a destination through a travelable region, even when the travelable region is complicated such as in an airport and near a toll booth.

### Means to Solve the Problem

A path planning apparatus according to the present disclosure is a path planning apparatus configured to plan a path of a moving body. The path planning apparatus includes: a travelable region calculation unit configured to calculate a travelable region of the moving body, based on surrounding information of the moving body; a target state calculation unit configured to calculate target state quantity including at least a target position of the moving body; a state prediction unit configured to predict at least current state quantity of the moving body and state quantity of the moving body at one or more positions between a current position and the target position of the moving body, and thereby generate one or more path candidates; a predicted state evaluation unit configured to evaluate the one or more path candidates based on the target state quantity and the travelable region, and output evaluation results; and a path generation unit configured to generate the path from the one or more path candidates based on the evaluation results, and output the path to a motion controller configured to control the moving body based on the path.

### Effects of the Invention

According to the path planning apparatus of the present disclosure, a path up to the target state quantity is evaluated based on the target state quantity including the target position of the moving body, and the travelable region, and the path is generated based on evaluation results. Therefore, even when the travelable region is complicated, a destination can be reached through the travelable region.

### BRIEF DESCRIPTION OF DRAWINGS

FIG. 1 is a block diagram illustrating an example of a schematic configuration of a moving body equipped with a path planning apparatus according to a first embodiment.

FIG. 2 is a diagram illustrating an example of a travelable region according to the first embodiment.

FIG. 3 is a diagram illustrating an example of target state quantity according to the first embodiment.

FIG. 4 is a diagram illustrating an example of a path point calculated by a path point calculation unit in the path planning apparatus according to the first embodiment.

FIG. 5 is a diagram illustrating an example of a path generated by a path generation unit in the path planning apparatus according to the first embodiment.

FIG. 6 is a flowchart illustrating an operation of the path planning apparatus according to the first embodiment.

FIG. 7 is a diagram illustrating an example of information acquired from an information acquisition unit in the path planning apparatus according to the first embodiment.

FIG. 8 is a diagram illustrating an example in which the information acquired from the information acquisition unit is converted into a moving body coordinate system in the path planning apparatus according to the first embodiment.

FIG. 9 is a diagram illustrating an example of prediction of the travelable region in the path planning apparatus according to the first embodiment.

FIG. 10 is a diagram illustrating another example of prediction of the travelable region in the path planning apparatus according to the first embodiment.

FIG. 11 is a diagram illustrating an example of the travelable region in the path planning apparatus according to the first embodiment.

FIG. 12 is a diagram illustrating an example of the travelable region in the path planning apparatus according to the first embodiment.

FIG. 13 is a diagram illustrating an example of the travelable region in the path planning apparatus according to the first embodiment.

FIG. 14 is a diagram illustrating an example of the target state quantity in the path planning apparatus according to the first embodiment.

FIG. 15 is a diagram illustrating an example of the target state quantity reset in the path planning apparatus according to the first embodiment.

FIG. 16 is a diagram illustrating an example of setting an upper limit value of a speed among the target state quantities in the path planning apparatus according to the first embodiment.

FIG. 17 is a diagram illustrating an example of setting an upper limit value of a speed among the target state quantities in the path planning apparatus according to the first embodiment.

FIG. 18 is a diagram illustrating an example of state quantity predicted using particle filters in the path planning apparatus according to the first embodiment.

FIG. 19 is a diagram illustrating an example of input values set depending on a shape of the travelable region in the path planning apparatus according to the first embodiment.

FIG. 20 is a diagram illustrating an example of input values set depending on a shape of the travelable region in the path planning apparatus according to the first embodiment.

FIG. 21 is a diagram illustrating an example of setting of input values when a deviation between the current state quantity and the target state quantity of the moving body is large in the path planning apparatus according to the first embodiment.

FIG. 22 is a diagram illustrating an example of observation variables in the path planning apparatus according to the first embodiment.

FIG. 23 is a diagram illustrating an example of weighting of particles outside of the travelable region in the path planning apparatus according to the first embodiment.

FIG. 24 is a diagram illustrating an example of weighting of particles inside of the travelable region in the path planning apparatus according to the first embodiment.

FIG. 25 is a diagram illustrating an example of weighting of particles inside of the travelable region in the path planning apparatus according to the first embodiment.

FIG. 26 is a diagram illustrating an example of weighting of particles inside of the travelable region in the path planning apparatus according to the first embodiment.

FIG. 27 is a diagram illustrating an example of weighting of particles inside of a predicted travelable region according to the first embodiment.

FIG. 28 is a diagram illustrating an example of setting of an evaluation weight in the path planning apparatus according to the first embodiment.

FIG. 29 is a diagram illustrating an example of processing of obtaining a plurality of path points to reach the target state quantity in the path planning apparatus according to the first embodiment.

FIG. 30 is a diagram illustrating an example of path generation until reaching the target state quantity in the path planning apparatus according to the first embodiment.

FIG. 31 is a diagram illustrating an example of path generation until reaching the target state quantity in the path planning apparatus according to the first embodiment.

FIG. 32 is a block diagram illustrating an example of a schematic configuration of a moving body equipped with a path planning apparatus according to a second embodiment.

FIG. 33 is a diagram illustrating a method of deriving a polynomial connecting the moving body and the target position in the path planning apparatus according to the second embodiment.

FIG. 34 is a diagram illustrating a method of deriving a polynomial connecting the moving body and the target position in the path planning apparatus according to the second embodiment.

FIG. 35 is a diagram illustrating a method of deriving a polynomial connecting the moving body and the target position in the path planning apparatus according to the second embodiment.

FIG. 36 is a diagram illustrating weighting when predicted state quantity is greatly deviated from the current state quantity of the moving body.

FIG. 37 is a diagram illustrating weighting when predicted state quantity is greatly deviated from the state quantity of the path point previously calculated.

FIG. 38 is a diagram illustrating a hardware configuration for implementing the path planning apparatuses according to the first and second embodiments.

FIG. 39 is a diagram illustrating a hardware configuration for implementing the path planning apparatuses according to the first and second embodiments.

### DESCRIPTION OF EMBODIMENTS

### First Embodiment

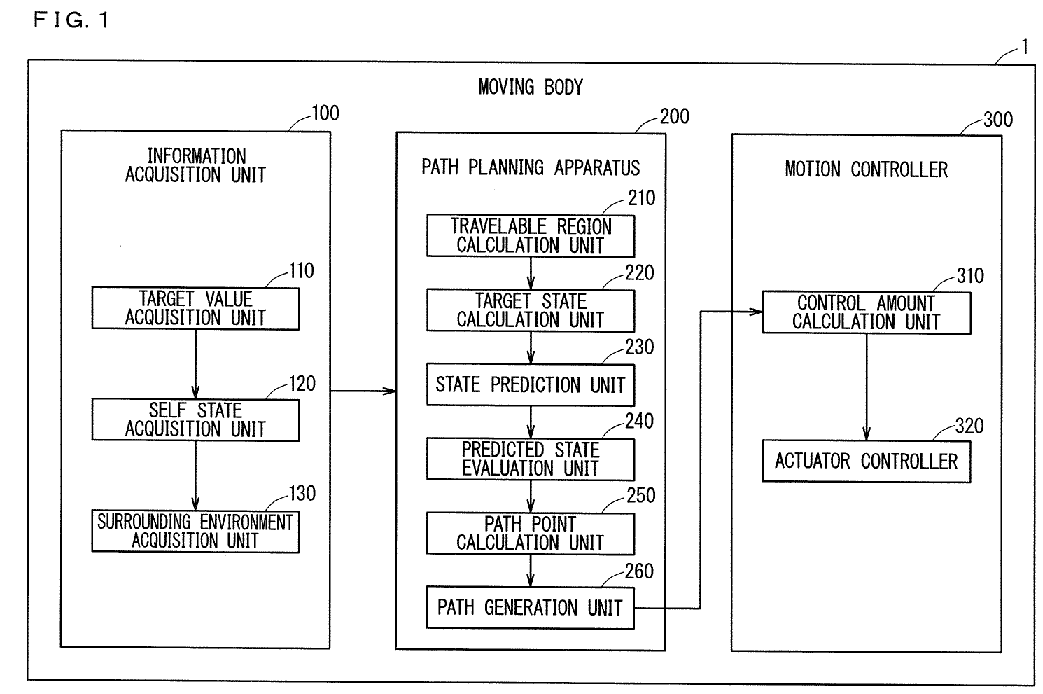

FIG. 1 is a block diagram illustrating an example of a schematic configuration of a moving body 1 equipped with a path planning apparatus according to a first embodiment. The moving body 1 includes a path planning apparatus 200 that generates a path to be traveled by the moving body 1 based on destination information of a destination to be reached by the moving body 1, surrounding environment information of the moving body 1, and information obtained from an information acquisition unit 100 that acquires a self state of the moving body 1, and a motion controller 300 that controls motion of the moving body 1 based on the path generated by the path planning apparatus 200.

The information acquisition unit 100 includes a target value acquisition unit 110, a self state acquisition unit 120, and a surrounding environment acquisition unit 130.

The target value acquisition unit 110 acquires information such as a target position to be reached by the moving body, a target speed, and a target azimuth. The target value acquisition unit 110 acquires information from infrastructure information received from controlling, information specified by a user in advance, a predetermined position in map information stored by the moving body, and the like, for example. Here, the map information stored by the moving body refers to, for example, a map of a car navigation device or a point cloud map generated using simultaneous localization and mapping (SLAM) or the like, rather than a high-accuracy map.

Examples of the target position include an entrance of a gate or a position of a bar at a toll booth, a position of a refuge on an expressway, a nose wheel part of an airplane for a towing tractor, and a position of the moving body 1 specified by a user. Examples of the target speed include a legal speed limit and a specified speed set by a user in advance. The target azimuth is a target angle at the time of passing through the target position, examples of which include a direction perpendicular to a gate at the time of passing through the gate.

The self state acquisition unit 120 acquires the current state of the moving body itself. Examples of the self state acquisition unit 120 include a speed sensor, an acceleration sensor, an inertial measurement unit, a steering angle sensor, a steering torque sensor, a yaw rate sensor, and a global satellite positioning system (global navigation satellite system (GNSS)) sensor. Here, the inertial measurement unit is hereinafter referred to as an inertial measurement unit (IMU) sensor.

The surrounding environment acquisition unit 130 acquires a wall around the moving body, a position, a speed, and an azimuth of a moving obstruction, and space information of a travelable space with no obstructions. Examples of the surrounding environment acquisition unit 130 include millimeter-wave radar, a camera, Light Detection and Ranging (LiDAR), sonar, a vehicle-to-vehicle communication apparatus, and a road-to-vehicle communication apparatus.

The path planning apparatus 200 includes a travelable region calculation unit 210, a target state calculation unit 220, a state prediction unit 230, a predicted state evaluation unit 240, a path point calculation unit 250, and a path generation unit 260.

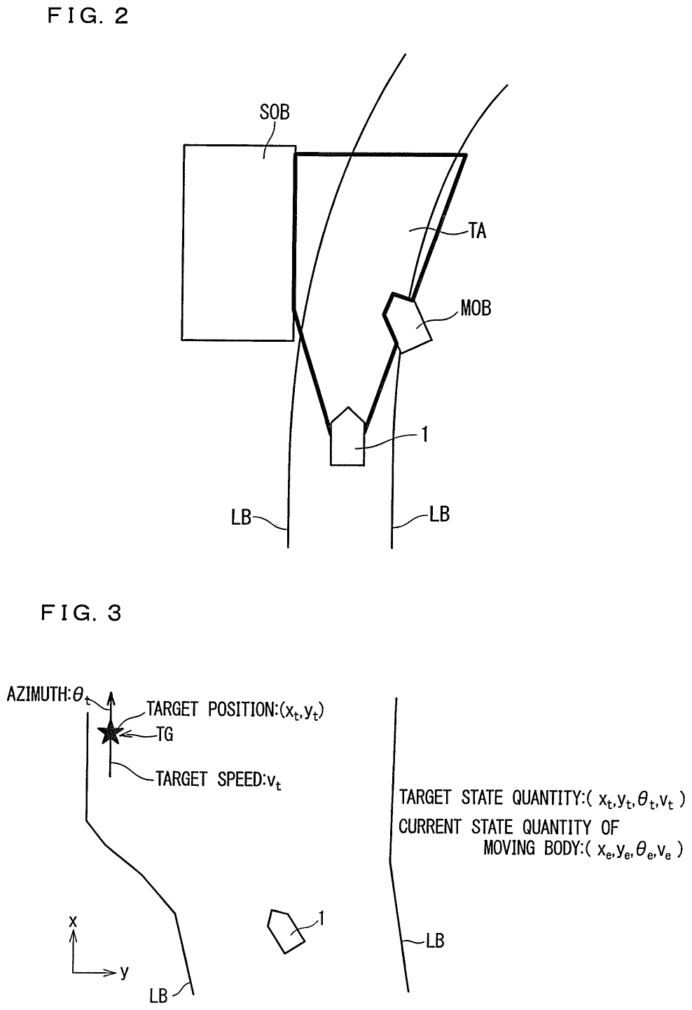

The travelable region calculation unit 210 calculates a travelable region with no obstructions in which the moving body 1 can travel, based on surrounding information of the moving body 1 acquired from the surrounding environment acquisition unit 130. FIG. 2 illustrates an example of the travelable region. In FIG. 2, there is a stationary obstruction SOB on the left side of the moving body 1 in its traveling direction, a moving obstruction MOB is about to enter a traveling traffic lane, which is defined by right and left traffic lane boundaries LB, from the right side in the traveling direction, and a travelable region TA without the stationary obstruction SOB and the moving obstruction MOB is indicated by a thick line. As illustrated in FIG. 2, the travelable region TA is not necessarily limited to the traveling traffic lane defined by the traffic lane boundaries LB, such as white lines, on a road.

The target state calculation unit 220 calculates target state quantity in the destination to be reached by the moving body 1, based on the information from the target value acquisition unit 110. The target state quantity includes at least the target position of the moving body 1. FIG. 3 illustrates an example of the target state quantity.

FIG. 3 illustrates a road without white lines, such as a place in front of an ETC gate, and here, the traffic lane boundary LB is a wall, a guard rail, or the like, instead of a white line. In FIG. 3, target state quantity TG includes coordinates (xₜ, yₜ) of the target position, a target azimuth θₜ, and a target speed vi at time t. Note that the current state quantity of the moving body 1 is represented by (xₑ, yₑ, θₑ, vₑ).

The state prediction unit 230 predicts at least the current state quantity of the moving body 1 and the state quantity of the moving body 1 at one or more positions between the current position and the target position of the moving body 1, and thereby generates one or more path candidates. Thus, for example, through use of state estimation calculation using a motion model of the moving body, a predetermined plurality of inputs are input to the motion model of the moving body to predict the state quantity of at least one next step ahead of the plurality of inputs, that is, one sampling time ahead in a control cycle, and thereby one or more path candidates are generated. In the present embodiment, particle filters are used as an example of a method for state estimation.

The particle filters are a method of predicting time-series data using a probability density distribution, and may be referred to as sequential Monte Carlo methods. Further, the particle filters as state estimation calculation approximate a probability density distribution of a state using a plurality of particles. For example, when there are many particles having certain state quantity, using the particle filters as its state estimation calculation enables estimation of the whole probability density distribution, and thus the frequency of outputting a local optimal solution can be reduced.

The predicted state evaluation unit 240 assigns a weight to each predicted state quantity, that is, each particle, to obtain weighted path candidates, evaluates the weighted path candidates based on their weights, and outputs evaluation results. In this case, weights are assigned based on the target state quantity calculated in the target state calculation unit 220 and the travelable region calculated in the travelable region calculation unit 210. When a path point is calculated in the path point calculation unit 250 to be described later, with the weights, the state quantity with high likelihood can be calculated by calculating a weighted average of a plurality of state quantities predicted in the state prediction unit 230 based on a value of the weight of each of the predicted state quantities.

For example, if a weighting coefficient of the state quantity outside of the travelable region is set to 0, in calculation of the weighted average, the state quantity is multiplied by the weighting coefficient of 0, and thus the state quantity can be prevented from being the path point outside of the travelable region, and a path that is ensured to be a path inside of the travelable region TA can be generated.

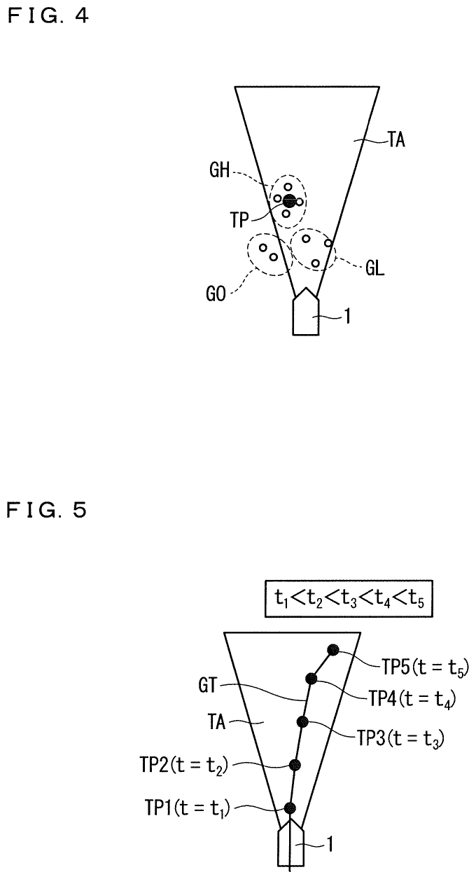

The path point calculation unit 250 calculates the path point from the path candidates. Specifically, the path point calculation unit 250 performs calculation of calculating the weighted average of the predicted state quantities predicted in the state prediction unit 230 according to the weights assigned by the predicted state evaluation unit 240, and then calculating the state quantity subjected to the weighted average as the path point. FIG. 4 illustrates a conceptual diagram of the calculation.

As illustrated in FIG. 4, inside of and near the travelable region TA, there are a particle group G0 of state quantities having a weighting coefficient of 0, a particle group GL of state quantities having a low weighting coefficient, and a particle group GH of state quantities having a high weighting coefficient, and the state quantity subjected to the weighted average in the particle group GH of state quantities having the high weighting coefficient is used as a path point TP. Further, the state quantity whose weight assigned by the predicted state evaluation unit 240 is the highest may be used as the path point.

The path generation unit 260 generates a path out of the path candidates based on the evaluation results, and outputs the path to the motion controller 300 that controls the moving body 1 based on the generated path. Specifically, the path generation unit 260 outputs a point sequence including path points at respective discrete times calculated in the path point calculation unit 250 to the motion controller 300 as a generated path. FIG. 5 illustrates a conceptual diagram of the generated path.

As illustrated in FIG. 5, path points TP1, TP2, TP3, TP4, and TP5 respectively at discrete times t₁, t₂, t₃, t₄, and t₅ are illustrated in the travelable region TA, and a generated path GT is obtained by the five path points.

The motion controller 300 includes a control amount calculation unit 310 and an actuator controller 320.

The control amount calculation unit 310 calculates a target control value for the moving body 1 for traveling along the target path by using the path generated in the path generation unit 260 as the target path, and outputs the target control value to the actuator controller 320.

The actuator controller 320 is a controller equipped in the moving body 1, and causes an actuator to operate so that the moving body follows the target control value calculated in the control amount calculation unit 310. Examples of the actuator include steering, a driving motor, and brakes.

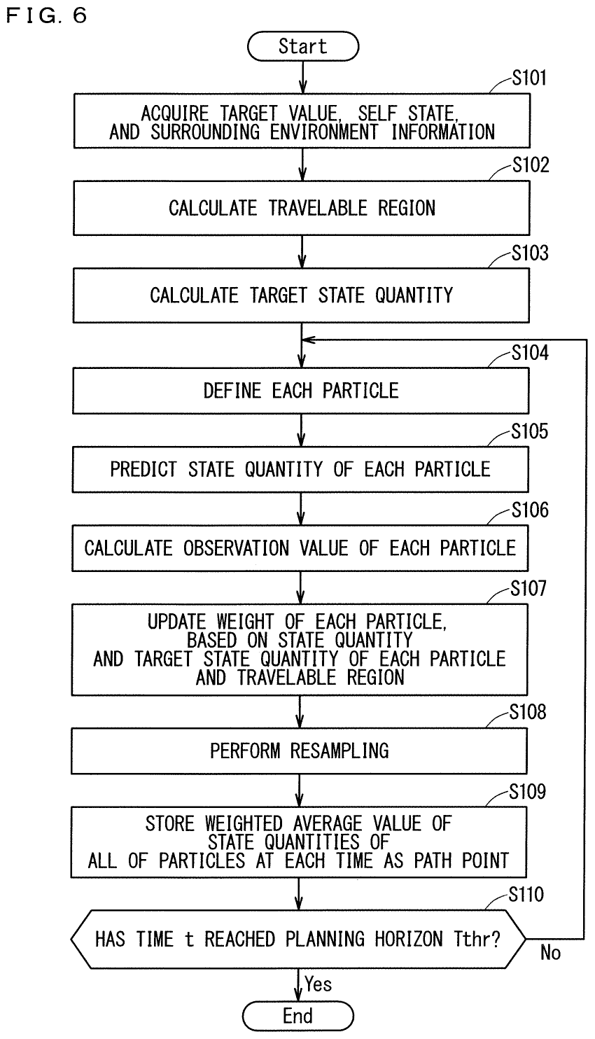

Next, an example of an operation of the path planning apparatus 200 according to the first embodiment will be described with reference to the flowchart illustrated in FIG. 6. The following will describe a case using particle filters. Note that “one step” hereinafter refers to one sampling time in a control cycle.

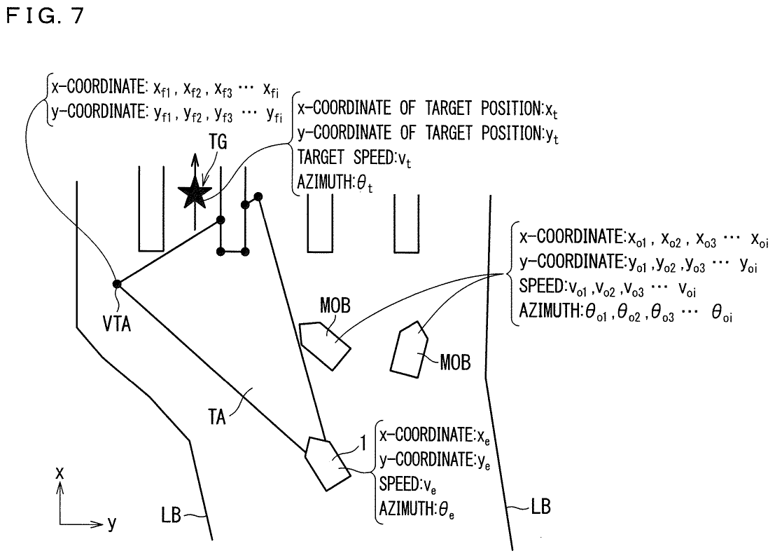

First, as input information of the path planning apparatus 200, target values, such as the target position, the target speed, and the target azimuth, are acquired from the target value acquisition unit 110, self states, such as the position, the speed, and the azimuth of the moving body, are acquired from the self state acquisition unit 120, and surrounding environment information, such as coordinates of each vertex, the position of the moving obstruction, and the speed in the travelable region, are acquired from the surrounding environment acquisition unit 130 (Step S101). FIG. 7 illustrates a conceptual diagram of the input information in this case.

In FIG. 7, coordinates of a plurality of vertices VTA defining the travelable region TA include an x-coordinate being represented by x_{f1}, x_{f2}, x_{f3}, . . . , x_{fi}, and a y-coordinate being represented by y_{f1}, y_{f2}, y_{f3}, . . . , y_{fi}.

The target state quantity TG includes coordinates (xₜ, yₜ) of the target position, a target azimuth θₜ, and a target speed vₜ, and the current self state quantity of the moving body 1 includes an x-coordinate being represented by xₑ, an x-coordinate being represented by yₑ, a speed being represented by vₑ, and an azimuth being represented by Θₑ.

Further, coordinates of each moving obstruction MOB include an x-coordinate being represented by x_{O1}, x_{O2}, x_{O3}, . . . , x_{Oi}, a y-coordinate being represented by y_{O1}, y_{O2}, y_{O3}, . . . , y_{Oi}, a speed being represented by v_{O1}, v_{O2}, v_{O3}, . . . , v_{Oi}, and an azimuth being represented by θ_{O1}, θ_{O2}, θ_{O3}, . . . , θ_{Oi}.

In FIG. 7, the travelable region TA is partially missing due to presence of an obstruction, and the plurality of vertices VTA are located along an outline of the obstruction.

Note that, in the present embodiment, each vertex of the travelable region TA is extracted as information of the travelable region TA. However, information of a line such as a circle or an ellipse may be used.

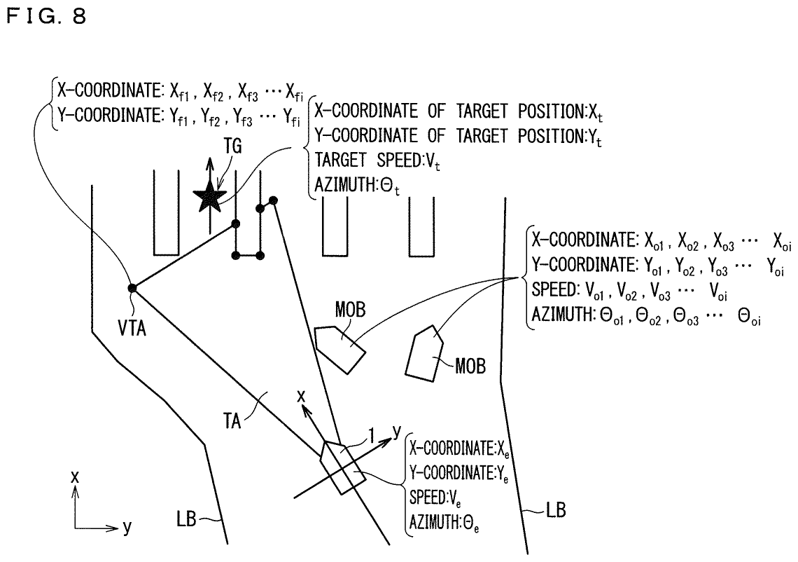

Further, by using the self states obtained from the self state acquisition unit 120, values converted into a moving body coordinate system may be used, in which the position of the moving body 1 is represented as the origin, the direction of the moving body 1 is represented as the x-axis, and a direction perpendicular to the direction of the moving body is represented as the y-axis, as illustrated in FIG. 8. Such values of the moving body coordinate system are hereinafter used.

As illustrated in FIG. 8, in the moving body coordinate system, coordinates of the plurality of vertices VTA include an X-coordinate being represented by X_{f1}, X_{f2}, X_{f3}, . . . , X_{fi}, and a Y-coordinate being represented by Y_{f1}, Y_{f2}, Y_{f3}, . . . , Y_{fi}.

The target state quantity TG includes coordinates (Xₜ, Yₜ) of the target position, a target azimuth Θₜ, and a target speed Vₜ, and the current self state quantity of the moving body 1 includes an X-coordinate being represented by Xₑ, a Y-coordinate being represented by Yₑ, a speed being represented by Vₑ, and an azimuth being represented by Θₑ.

Further, coordinates of each moving obstruction MOB include an X-coordinate being represented by X_{O1}, X_{O2}, X_{O3}, . . . , X_{Oi}, a Y-coordinate being represented by Y_{O1}, Y_{O2}, Y_{O3}, . . . , Y_{Oi}, a speed being represented by V_{O1}, V_{O2}, V_{O3}, . . . , V_{Oi}, and an azimuth being represented by Θ_{O1}, Θ_{O2}, Θ_{O3}, . . . , Θ_{Oi}.

In coordinate transformation of each value related to target value information, the following Expression (1) is used.

$$\begin{matrix}[ Expression 1 ] & \\ ( \begin{matrix}{X}_{t} \\ {Y}_{t}\end{matrix} ) = ( \begin{matrix}cos ( - {θ}_{e} ) & - sin ( - {θ}_{e} ) \\ sin ( - {θ}_{e} ) & cos ( - {θ}_{e} )\end{matrix} ) ( \begin{matrix}{x}_{t} - {x}_{e} \\ {y}_{t} - {y}_{e}\end{matrix} ) & ( 1 )\end{matrix}$$

$${Θ}_{t} = {θ}_{t} - {θ}_{e} …$$

In coordinate transformation of each value related to moving obstruction information, the following Expression (2) is used.

$$\begin{matrix}[ Expression 2 ] & \\ ( \begin{matrix}{X}_{oi} \\ {Y}_{oi}\end{matrix} ) = ( \begin{matrix}cos ( - {θ}_{e} ) & - sin ( - {θ}_{e} ) \\ sin ( - {θ}_{e} ) & cos ( - {θ}_{e} )\end{matrix} ) ( \begin{matrix}{x}_{oi} - {x}_{e} \\ {y}_{oi} - {y}_{e}\end{matrix} ) & ( 2 )\end{matrix}$$

$${Θ}_{oi} = {θ}_{oi} - {θ}_{e} …$$

In coordinate transformation of each value related to each vertex of the travelable region TA, the following Expression (3) is used.

$$\\ \begin{matrix}[ Expression 3 ] & \\ ( \begin{matrix}{X}_{fi} \\ {Y}_{fi}\end{matrix} ) = ( \begin{matrix}cos ( - {θ}_{e} ) & - sin ( - {θ}_{e} ) \\ sin ( - {θ}_{e} ) & cos ( - {θ}_{e} )\end{matrix} ) ( \begin{matrix}{x}_{fi} - {x}_{e} \\ {y}_{fi} - {y}_{e}\end{matrix} ) & ( 3 )\end{matrix}$$

$$\\ {Θ}_{fi} = {θ}_{fi} - {θ}_{e}$$

Here, description returns back to the flowchart of FIG. 6. After the surrounding environment information is acquired in Step S101, the travelable region TA with no obstructions in which the moving body 1 can travel is calculated in the travelable region calculation unit 210, based on the information acquired from the surrounding environment acquisition unit 130 (Step S102). In the present embodiment, the X-coordinates X_{f1} to X_{fi} and the Y-coordinates Y_{f1} to Y_{fi} related to each vertex VTA of the travelable region TA in the moving body coordinate system illustrated in FIG. 8 are used for path generation.

Note that, instead of using the X-coordinates X_{f1} to X_{fi} and the Y-coordinates Y_{f1} to Y_{fi} related to each vertex VTA of the travelable region TA for path generation, based on time series variation of a shape of the travelable region TA calculated in the past, a travelable region in time later than the travelable region calculated at the current time may be predicted and used as a predicted travelable region, and the travelable region calculated at the current time and the predicted travelable region may be combined together and used as the travelable region to be used for path generation.

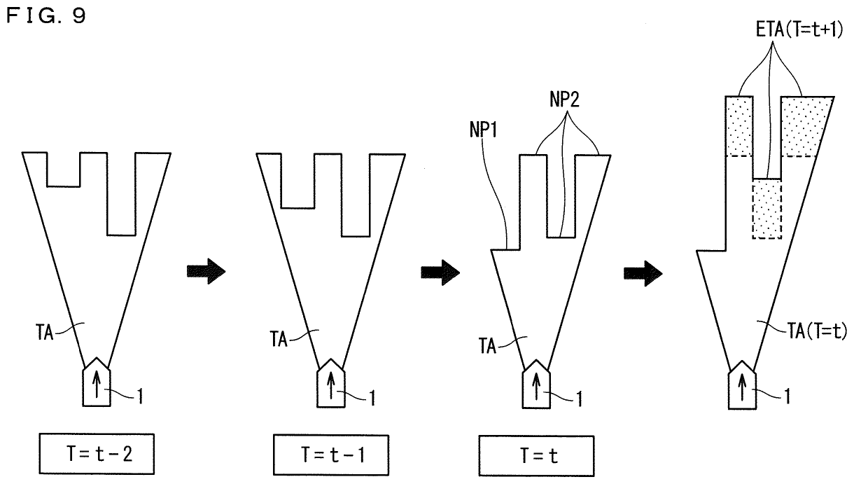

FIG. 9 is a conceptual diagram illustrating a method of predicting the travelable region, based on time series variation of the shape of the travelable region TA. In FIG. 9, the current time is represented by t as time T, time earlier than t by one sampling time in the control cycle is represented by t−1, time further earlier than t−1 by one sampling time is represented by t−2, and time later than the time t by one sampling time is represented by t+1.

In FIG. 9, the moving body 1 travels forward in a direction of the arrow, and the travelable region TA is partially missing due to presence of an obstruction ahead. From the variation of the past travelable region TA at the time t−2, the past travelable region TA at the time t−1, and the current travelable region TA at the time t over time, it can be understood that there are a part NP1 that changes in a backward direction as much as the moving body 1 travels and a part NP2 that does not change or only slightly changes despite traveling of the moving body 1. It is likely that the part NP1 is a stationary obstruction, and it is likely that the part NP2 is a moving obstruction. From the information as described above, when a future travelable region at the time t+1 is predicted, a hatched region in the figure on the right end of FIG. 9 is a predicted travelable region ETA, and by combining the current travelable region TA at the time t and the predicted travelable region ETA together, the current travelable region TA can be extended.

By using the predicted travelable region ETA, the path can be generated up to a region farther than the travelable region that can be recognized at the current time and is obtained by external sensors. The region may be the travelable region in the future.

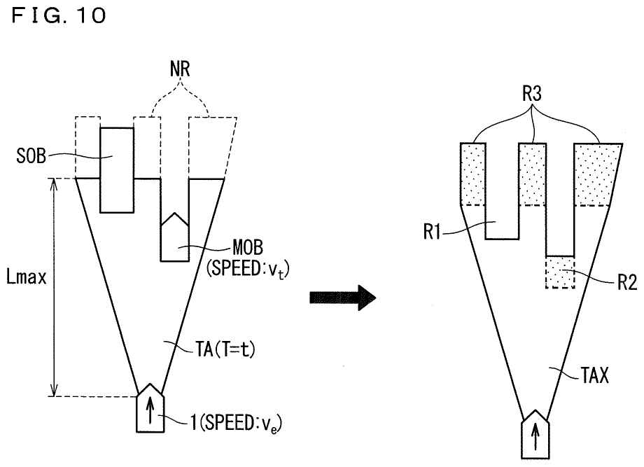

Further, based on a type of an obstruction outside of the travelable region TA, the predicted travelable region may be calculated and used for path generation. FIG. 10 is a conceptual diagram illustrating a method of predicting the travelable region, based on a type of an obstruction. Note that examples of the type of an obstruction include a wall, another vehicle being stopped, and another vehicle in motion. When the obstruction is another vehicle in motion, the surrounding environment acquisition unit 130 acquires not only the position but also the speed and the like of the another vehicle in motion. Then, the travelable region calculation unit 210 calculates the predicted travelable region, based on the position, the speed, and the like of the another vehicle in motion. Thus, the predicted travelable region also includes a region that is not included in the travelable region calculated at the current time. This means that even when a region is determined as being untravelable at the current time, the region is determined as being travelable in the future.

In FIG. 10, the current travelable region TA at the current time t for the moving body 1 at the speed vₑ is illustrated as a left figure, and a future predicted travelable region TAX that is time tₓ later than the current time is illustrated in a right figure.

In the left figure of FIG. 10, a maximum recognized distance of the travelable region TA is represented by Lₘₐₓ, and a region NR with no obstructions is indicated by a broken line ahead of the farthest part of the travelable region TA. Further, the travelable region TA is partially missing due to presence of the stationary obstruction SOB and the moving obstruction MOB at the speed v_{O}.

In the right figure of FIG. 10, a point where the stationary obstruction SOB is present ahead is a region R1 that cannot be travelable even in the future, and a point where the moving obstruction MOB is present ahead is an extended region R2, which is obtained by extending the travelable region TA, on an assumption that the travelable region is to extend in the future in a traveling direction of the moving obstruction MOB. A length to be extended is represented by (v_{O}−vₑ)×tₓ. Further, a point beyond the maximum recognized distance Lmax of the travelable region TA is an extended region R3, which is obtained by extending the travelable region TA, on an assumption that a region beyond the point is also travelable. A length to be extended is represented by vₑ×tₓ.

By using the predicted travelable region TAX, the path can be generated up to a position farther than the travelable region that can be recognized at the current time and is obtained by external sensors. This enhances reliability because the travelable region is predicted based on actual movement of the obstruction. Further, the travelable region TA can be predicted considering not only actual movement of the obstruction but also time series variation of the shape of the travelable region TA as illustrated in FIG. 9. This further enhances reliability.

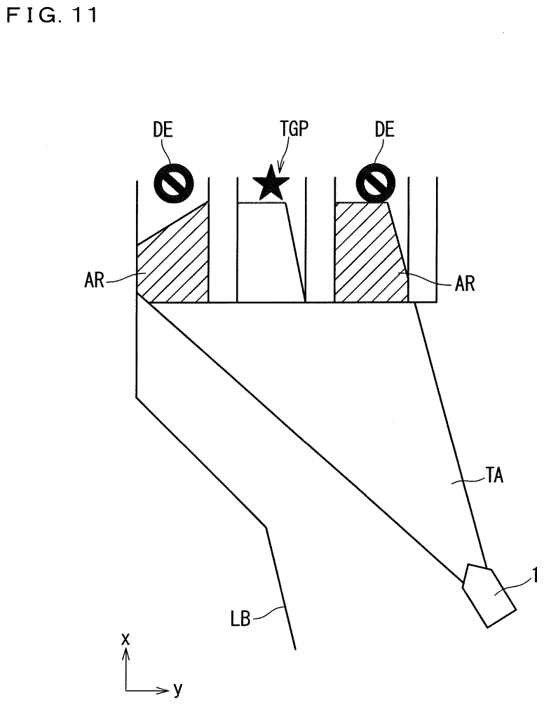

Further, in calculation of the travelable region TA in Step S102, when there is a region that is travelable but may be a dead end, processing of excluding the region from the travelable region TA is performed as necessary. FIG. 11 is a conceptual diagram illustrating the processing.

FIG. 11 illustrates a scene in which there is a narrow passage, such as an ETC gate, ahead of the moving body 1, and a target position TGP is present inside a passable gate. Other gates are untravelable and are dead ends DE that cannot be traveled on in the future, and are excluded from the travelable region TA as excluded regions AR.

Regarding a region that may be a dead end, for example, a place with its value in a y-axis direction having a deviation despite a value in an x-axis direction being a value substantially the same as the target position TGP is regarded as a dead end. Alternatively, when an overhead view, an aerial photograph, or the like as that in FIG. 11 is obtained, a region where there is a wall in front of the target position TGP, a region in which the target position TGP is surrounded by a wall, or the like is detected using image processing technology. When position information, such as under construction and an inoperable ETC gate, is obtained by utilizing the infrastructure information, such an unpassable region is compared with the travelable region TA, and a region in the travelable region TA in which the moving body 1 cannot travel in the future is regarded as a region that may be a dead end.

This enables generation of a path for preventing from being surrounded by a dead end and being immovable before reaching the target position TGP, even inside the travelable region TA.

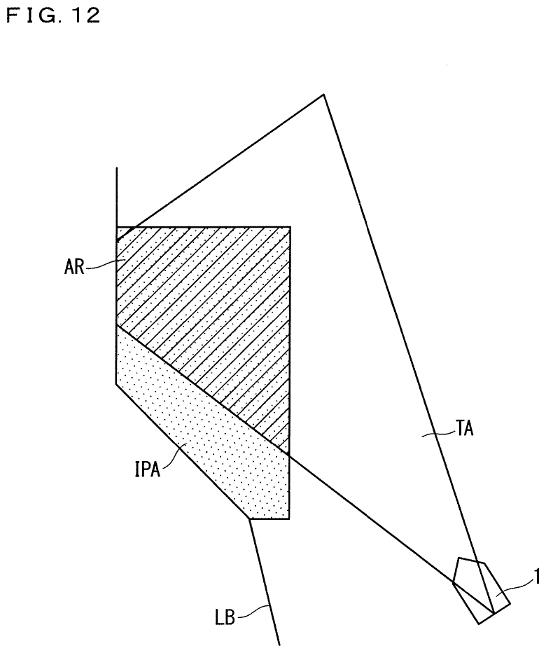

Further, in calculation of the travelable region TA in Step S102, when there is a region that is travelable but prohibits entry, processing of excluding the region from the travelable region TA is performed as necessary. FIG. 12 is a conceptual diagram illustrating the processing.

FIG. 12 illustrates a scene in which an entry-prohibited area IPA is provided ahead of the moving body 1. Examples of the entry-prohibited area IPA include a region that is under construction or the like and is a region not surrounded by an obstruction such as a fence. A region where the travelable region TA and the entry-prohibited area IPA overlap is excluded from the travelable region TA as the excluded region AR.

Regarding the entry-prohibited area IPA, when an overhead view, an aerial photograph, or the like as that in FIG. 12 is obtained, for example, a region under construction or the like is detected using image processing technology, and a region that does not allow entry, such as under construction, is detected using image processing technology by using a front camera attached to the moving body 1. When the position information, such as under construction, is obtained by utilizing the infrastructure information, such a region under construction or the like is compared with the travelable region, and a region under construction or the like in the travelable region TA is regarded as the entry-prohibited area IPA.

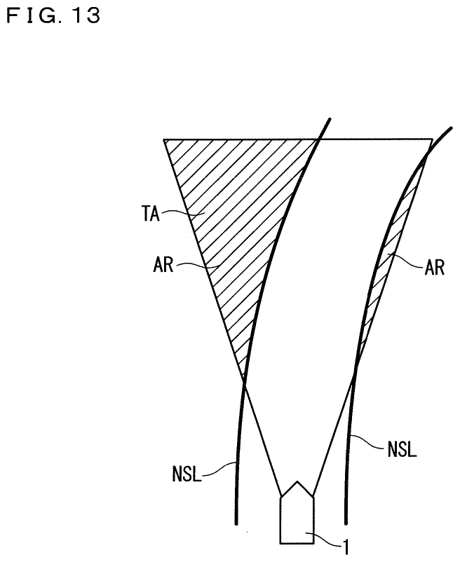

Further, in calculation of the travelable region TA in Step S102, when there is a cross-over prohibiting line that prohibits traveling across the cross-over prohibiting line, processing of making only a region in which the travelable region TA and the cross-over prohibiting line overlap travelable is performed. FIG. 13 is a conceptual diagram illustrating the processing.

FIG. 13 illustrates a scene in which cross-over prohibiting lines NSL are provided on right and left sides of the moving body 1 in the traveling direction. Examples of the cross-over prohibiting line NSL include a white solid line that prohibits traveling out of a traffic lane and a yellow solid line that prohibits traveling out of a traffic lane for overtaking, which are provided on a road surface. Further, rules such as prohibition of changing of a traffic lane within 30 m of an intersection and prohibition of changing of a traffic lane immediately in front of an ETC gate are also included. Further, a region surrounded by the travelable region TA and the cross-over prohibiting lines NSL is excluded from the travelable region TA as the excluded region AR, and only a region in which the travelable region TA and the cross-over prohibiting lines overlap is travelable.

As described above with reference to FIG. 11 to FIG. 13, the travelable region calculation unit 210 predicts a region in which the moving body 1 cannot travel in the future, based on the surrounding environment information of the moving body 1, and calculates a region obtained by excluding the predicted region as the travelable region TA. Note that the region that cannot be traveled in the future is not limited to the regions as illustrated in FIG. 11 to FIG. 13.

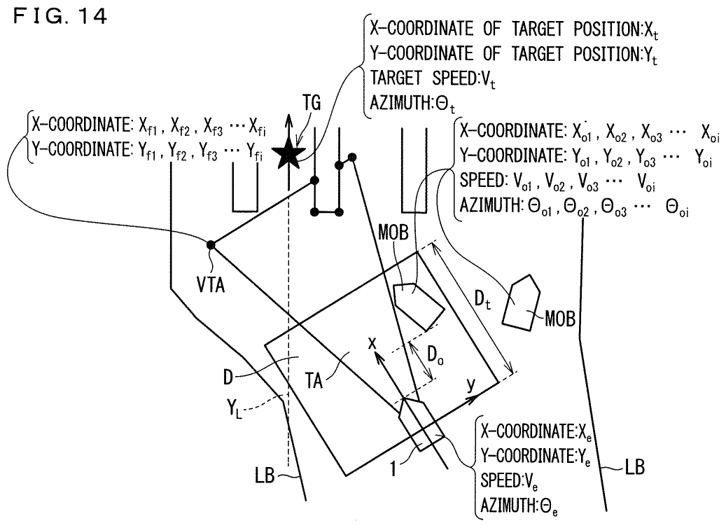

Here, description returns back to the flowchart of FIG. 6. After the travelable region TA is calculated in Step S102, the target state quantity to be reached by the moving body 1 is calculated in the target state calculation unit 220, based on the target values acquired in the target value acquisition unit 110 (Step S103). FIG. 14 illustrates a schematic diagram of the target state quantity according to the present embodiment.

Target state quantity Pₜ is expressed by the following Expression (4), where the target state quantity includes a target lateral position Y_{L}, a target speed Vₜ, and a target azimuth Θₜ representing a position in a direction perpendicular to the target position in a target azimuth direction calculated using the target position (Xₜ, Yₜ), the target speed Vₜ, and the target azimuth Θₜ, and further includes a target vehicle-to-vehicle distance Dₜ in order to make a distance Do from the moving obstruction MOB in a danger region D equal to or larger than the target vehicle-to-vehicle distance Dₜ, as illustrated in FIG. 14.

$$\\ \begin{matrix}[ Expression 4 ] & \\ {P}_{t} = \begin{matrix}[ {Y}_{L} & {V}_{t} & {Θ}_{t} & {{D}_{t} ]}^{T}\end{matrix} & ( 4 )\end{matrix}$$

By including the target speed Vₜ in the target state quantity, for example, a path travelable at any speed such as within a legal speed limit can be generated.

By including the target azimuth Θₜ in the target state quantity, for example, in entry to a narrow passage ahead in a scene of passing through a toll booth gate or the like, by setting the azimuth in a direction perpendicular to the gate to the target state quantity, a path to allow entry straight into the gate can be generated.

By including the target lateral position Y_{L} in the target state quantity and using only components of the target position in the sideways direction as the target state quantity for the moving body 1 that cannot move sideways, a deviation with respect to the target position in the sideways direction can be reduced at an early stage, and the target position can be brought into a state allowing passing in the target azimuth at an early stage.

The danger region D illustrated in FIG. 14 is defined as a safety vehicle-to-vehicle distance to be secured from a leading vehicle in motion and a stationary obstruction, and a distance for a person and another vehicle to keep out because when the moving body 1 is moving, there is a greater possibility of collision in the presence of a person and another vehicle near the moving body 1, and when there is a collision, this causes a great damage and is dangerous. In FIG. 14, the moving obstruction MOB is present inside of the danger region D, and the distance Do from the moving obstruction MOB is smaller than the target vehicle-to-vehicle distance Dₜ.

Further, the target state quantity Pₜ may be expressed in the following Expression (5), using the target position (Xₜ, Yₜ).

$$\\ \begin{matrix}[ Expression 5 ] & \\ {P}_{t} = \begin{matrix}[ {X}_{t} & {Y}_{t} & {V}_{t} & {Θ}_{t} & {{D}_{t} ]}^{T}\end{matrix} & ( 5 )\end{matrix}$$

Further, when at least the target position (Xₜ, Yₜ) is included in the target state quantity Pₜ, the target state quantity Pₜ may not use the target speed Vₜ, the target azimuth Θₜ, and the target vehicle-to-vehicle distance Dₜ. This is because when the target position (Xₜ, Yₜ) is at least included as the target state quantity, a path reachable to the target position can be generated in the path generation unit 260.

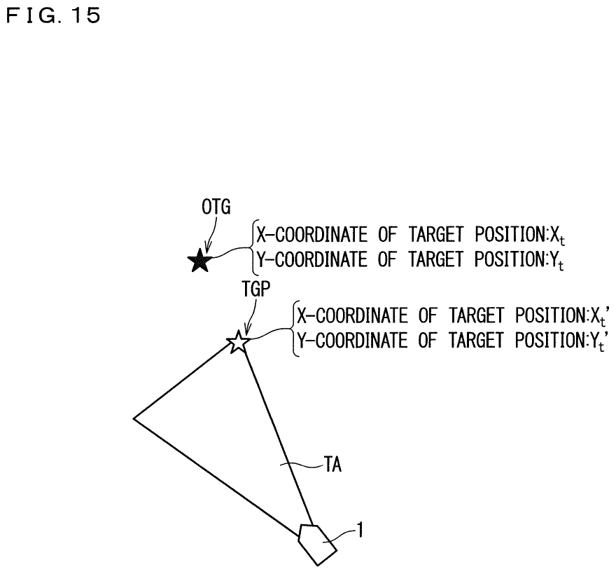

Further, when the target state quantity is outside of the travelable region TA, the target state calculation unit 220 may perform processing such that the state quantity inside of the travelable region TA closest to the target state quantity is set as the target state quantity. FIG. 15 is a conceptual diagram illustrating the processing.

FIG. 15 illustrates a case in which the target position (Xₜ, Yₜ) is used as the target state quantity, and an original target position OTGP is present outside of the travelable region TA. The target position inside of the travelable region TA closest to the original target position OTGP in a straight distance is around a right corner of the travelable region TA, and thus the target position TGP is set at the right corner.

By performing such processing, in comparison to a case in which the target position TGP is outside of the travelable region TA, the generated path is more easily set inside of the travelable region TA, which enables safe traveling.

Further, the target state calculation unit 220 may set an upper limit value to the target state quantity related at least to the speed among the target state quantities, depending on the shape of the travelable region TA calculated in the travelable region calculation unit 210. For example, an upper limit value is set to the target state quantity related to the speed when the travelable region TA is so narrow and when the recognized distance of the travelable region TA is so short that high-speed traveling is inhibited.

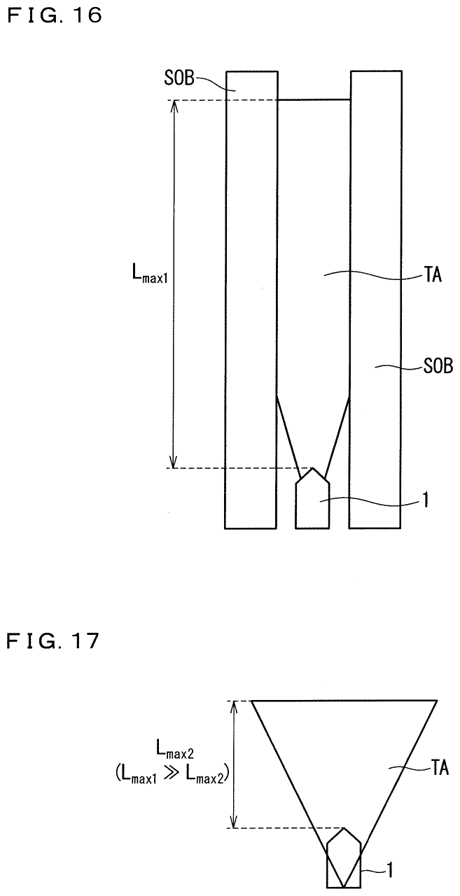

FIG. 16 is a conceptual diagram illustrating a scene in which the travelable region TA is narrow. As illustrated in FIG. 16, the stationary obstructions SOB are present on right and left sides of the moving body 1 at a close distance along the traveling direction of the moving body 1. The maximum recognized distance of the travelable region TA is Lₘₐₓ₁, and is approximately as long as the length of the stationary obstruction SOB but is narrow in width.

In this case, by setting an upper limit value to the target state quantity related to the target position or the target azimuth, the generated path is more easily set inside of the travelable region TA, which enables traveling that does not put mental burdens on occupants of the moving body 1.

FIG. 17 is a conceptual diagram illustrating a scene in which the recognized distance of the travelable region TA is short. As illustrated in FIG. 17, a recognized distance Lₘₐₓ₂ of the travelable region TA ahead of the moving body 1 in the traveling direction is significantly smaller than the maximum recognized distance Lₘₐₓ₁ of the travelable region TA illustrated in FIG. 16, which thus inhibits distant recognition.

Such a scene is assumed when the moving body 1 is a towing tractor and there is an airplane to be towed ahead of the moving body 1, when there is a wall at a close position ahead, and when a front detection distance of a camera sensor attached to the moving body 1 is short.

In this case, by setting an upper limit value to the target state quantity related to the speed, the generated path is more easily set inside of the travelable region TA, which enables traveling that does not put mental burdens on occupants of the moving body 1.

Here, description returns back to the flowchart of FIG. 6. After the target state quantity is calculated in Step S103, Nₚ particles are defined in the state prediction unit 230, based on the current state of the moving body (Step S104). The Nₚ particles include state quantities different from one another. Nₚ is an integer of 2 or greater. In the present embodiment, a state quantity P of the particle includes two-dimensional positions Xₚ and Yₚ, an azimuth Θₚ, a speed Vₚ, a steering angle δₚ, aᵥ, acceleration aₚ, and a steering angular velocity up of the moving body, and is expressed by the following Expression (6).

$$\\ \begin{matrix}[ Expression 6 ] & \\ P = \begin{matrix}[ {X}_{p} & {Y}_{p} & {Θ}_{p} & {V}_{p} & {δ}_{p} & {a}_{p} & {{u}_{p} ]}^{T}\end{matrix} & ( 6 )\end{matrix}$$

Note that the two-dimensional positions Xₚ and Yₚ and the azimuth Θₚ are represented in the coordinate system of FIG. 8 with reference to the current position and the current azimuth of the moving body 1. Further, the state quantity of an n-th particle is represented by Pₙ. Initial values of state variables are the same values in all of the particles. Initial values of the two-dimensional positions Xₚ and Yₚ and the azimuth Θₚ are 0, an initial value of the speed Vₚ is the current speed of the moving body 1, an initial value of the steering angle δₚ is the current steering angle of the moving body 1, and initial values of the acceleration aₚ and the steering angular velocity up are 0. Further, a weight W is defined for each of the particles, and an initial value of the weight W is equal in all of the particles, and is a value expressed by the following Expression (7), and time Tₚ is defined, and is set to an initial value of 0.

$$\\ \begin{matrix}[ Expression 7 ] & \\ W = 1 / Np & ( 7 )\end{matrix}$$

Note that the number of particles may be variable depending on the shape and the area of the travelable region TA, or may be variable depending on a degree of deviation from the target state quantity.

After the particles are defined in Step S104, in the state prediction unit 230, as many inputs as the number of random particles using uniform random numbers are given to the respective particles, and the state quantity in a discrete time length Ta is predicted (Step S105). A method of predicting the state of each particle will be described below.

Prediction of the state quantity of each particle is performed using a system model, and a model used in the present embodiment will be described below. State variables of the system model are two-dimensional positions Xₚ and Yₚ, an azimuth Θₚ, a speed Vₚ, and a steering angle op of the particle, and the state quantity is expressed by the following Expression (8).

$$\\ \begin{matrix}[ Expression 8 ] & \\ {P}_{x} = \begin{matrix}[ {X}_{p} & {Y}_{p} & {Θ}_{p} & {V}_{p} & {{δ}_{p} ]}^{T}\end{matrix} & ( 8 )\end{matrix}$$

Further, an input value Pᵤ to the system model includes acceleration a and a steering angular velocity u of the vehicle, and is expressed by the following Expression (9).

$$\\ \begin{matrix}[ Expression 9 ] & \\ {P}_{u} = \begin{matrix}[ a & {u ]}^{T}\end{matrix} & ( 9 )\end{matrix}$$

Further, a sideslip angle β of the moving body 1 is expressed by the following Expression (10).

[Expression 10]

β=tan⁻¹(tan(δ)/2) (10)

Here, the system model is expressed by the following Expression (11) as a differential equation, using a wheelbase L of the moving body 1.

$$\\ \begin{matrix}[ Expression 11 ] & \\ \frac{{dP}_{x}}{dt} = [ \begin{matrix}{V}_{p} \cdot cos ( θ + β ) / cos ( β ) \\ {V}_{p} \cdot sin ( θ + β ) / cos ( β ) \\ {V}_{p} \cdot tan ( {δ}_{p} ) / L \\ a \\ u\end{matrix} ] & ( 11 )\end{matrix}$$

Note that it can be said that the system model described above is a kinematic model in which a four-wheeled vehicle is approximated to a two-wheeled vehicle and mechanics is not taken into consideration. However, another vehicle motion model may be used, such as a two-wheeled vehicle model being a dynamic model in which a four-wheeled vehicle is approximated to a two-wheeled vehicle.

Among the input variables to the system model, for the acceleration a, regarding any upper limit value aₘₓ and any lower limit value aₘₙ set in advance, a value satisfying the following Expression (12) is determined using a uniform random number for each particle.

$$\\ \begin{matrix}[ Expression 12 ] & \\ {a}_{mx} \geq a \geq {a}_{mn} & ( 12 )\end{matrix}$$

Further, among the input variables to the system model, for the steering angular velocity u, regarding an upper limit value uₘₓ (>0) set in advance, satisfaction of the following Expression (13) is a first constraint condition for the steering angular velocity u.

$$\\ \begin{matrix}[ Expression 13 ] & \\ {u}_{mx} \geq \vert u \vert & ( 13 )\end{matrix}$$

Further, regarding an upper limit value δₘₓ (>0) related to the steering angle, a steering angle δ′ in a discrete time length Ta satisfying the following Expression (14) is a second constraint condition for the steering angular velocity u.

$$\\ \begin{matrix}[ Expression 14 ] & \\ {δ}_{mx} \geq \vert {δ}^{{}_{} ′} \vert & ( 14 )\end{matrix}$$

The steering angle δ′ in the discrete time length T_{d} is expressed by the following Expression (15).

$$\\ \begin{matrix}[ Expression 15 ] & \\ {δ}^{{}_{} ′} = δ + u \cdot Td & ( 15 )\end{matrix}$$

Thus, the second constraint condition is expressed by the following Expression (16).

$$\\ \begin{matrix}[ Expression 16 ] & \\ ( {δ}_{mx} - δ ) / Td \geq u \geq - ( {δ}_{mx} + δ ) / Td & ( 16 )\end{matrix}$$

For the steering angular velocity u among the input value Pᵤ to the system model, a value satisfying the first constraint condition and the second constraint condition is determined using a uniform random number for each particle.

As described above, state quantity Pₓ′ in the discrete time length Ta is predicted according to the system model described above, using the input value Pᵤ determined based on the steering angle upper limit value δₘₓ as a constraint. This enables prediction of the state of particles considering constraints.

The state quantity of each particle is updated using the predicted state quantity Pₓ′ and the input value Pᵤ, and is expressed by the following Expression (17). Further, a value obtained by adding the discrete time length T_{d} to the time T is used as time after the update.

$$\\ \begin{matrix}[ Expression 17 ] & \\ P = \begin{matrix}[ {P}_{x}^{{}_{} ′ T} & {{P}_{u}^{{}_{} T} ]}^{T}\end{matrix} & ( 17 )\end{matrix}$$

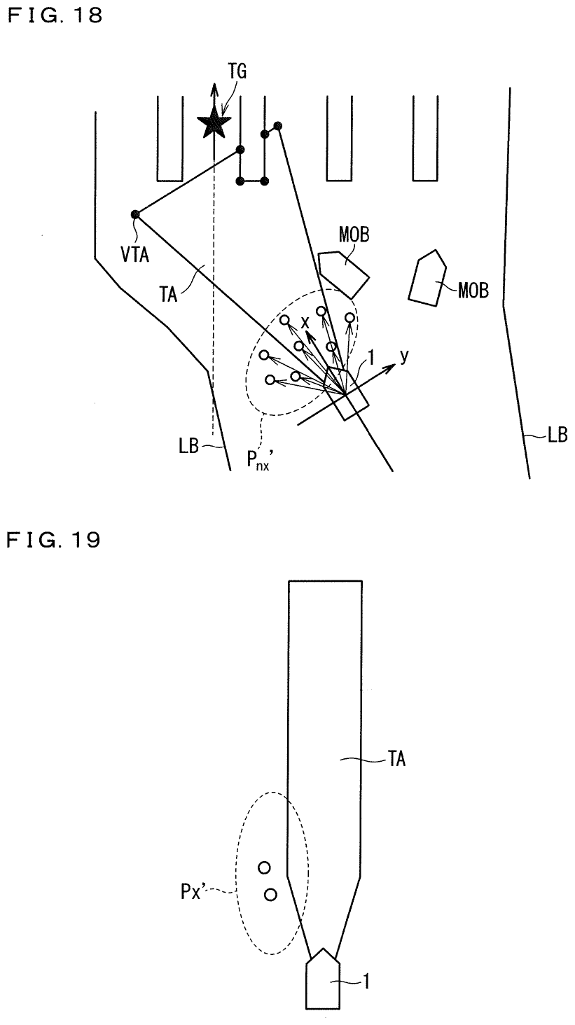

FIG. 18 illustrates a conceptual diagram of prediction of the state in the discrete time length T_{d}, where the predicted state quantity of each particle in the time Ta is represented by Pₙₓ′. In FIG. 18, predicted state quantities Pₙₓ′ of n particles in the time T_{d} are illustrated ahead of the moving body 1. In this manner, by predicting the state quantities using a plurality of particles, evaluation regarding outside or inside of the travelable region TA can be performed from a positional relationship between the point of each particle and the travelable region TA, and thus a path that can ensure being inside of the travelable region TA can be generated.

Note that, in calculation of the state prediction unit 230, inputs are determined using uniform random numbers in accordance with a uniform distribution in order to give random inputs. However, normal random numbers in accordance with a normal distribution or random inputs in accordance with another distribution may be used.

Further, in calculation of the state prediction unit 230, inputs that do not exceed any upper limit value set in advance are used. However, the inputs may be values that may be variable depending on the shape of the travelable region TA.

FIG. 19 is a conceptual diagram illustrating a case in which inputs are set according to the shape of the travelable region TA being narrow and long. As illustrated in FIG. 19, when the travelable region TA has an oblong shape, such an upper limit value of an input of the steering angular velocity u that does not cause the predicted state quantities Pₓ′ to be located outside of the travelable region TA as in the illustration is set, or a distribution of the input of the steering angular velocity u is narrowed. By performing such processing, the predicted state quantities are made to be easily generated.

Further, when the travelable region TA has a narrow and long shape, by reducing the number of inputs, the amount of calculation can be reduced.

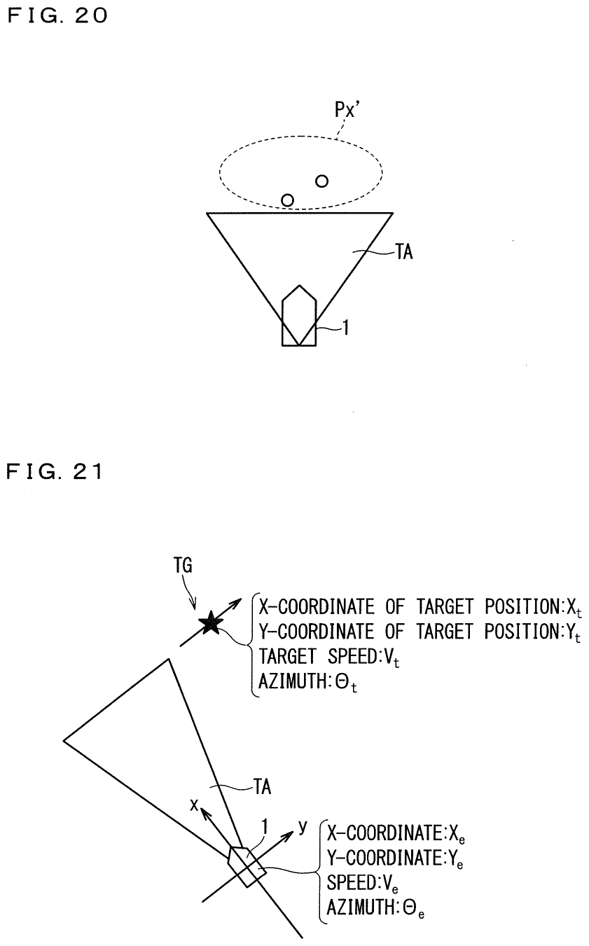

FIG. 20 is a conceptual diagram illustrating a case in which inputs are set according to the shape of the travelable region TA being wide. As illustrated in FIG. 20, when the travelable region TA has a wide shape, such an upper limit value of an input of the acceleration a that does not cause the predicted state quantities Pₓ′ to be located outside of the travelable region TA as in the illustration is set, a distribution of the input of the acceleration a is widened, or the number of inputs is increased. By performing such processing, the predicted state quantities are made to be easily generated.

Further, when the travelable region TA has a wide shape, by increasing the number of inputs, a more suitable path is made to be more easily obtained.

Note that, when a deviation between the current state quantity and the target state quantity of the moving body 1 is large, the state prediction unit 230 may increase the number of input values to the motion model of the moving body 1, whereas when the degree of deviation is small, the state prediction unit 230 may reduce the number of input values. FIG. 21 is a conceptual diagram illustrating setting of input values when a deviation between the current state quantity and the target state quantity is large.

As illustrated in FIG. 21, when a deviation between the azimuth target state quantity Θₜ and the azimuth Θ_{c} at the current position of the moving body 1 is large and the target position cannot be reached unless the steering angle is increased, the steering angular velocity is added as an input value to the motion model, and a path is predicted such that the steering angular velocity is increased.

In this case, a distribution of the steering angle is set wide. In other words, ranges of upper and lower limit values of the steering angle are set wide. Further, by increasing the number of input values, a more suitable path is made to be more easily obtained. With this, even when the deviation between the current state quantity and the target state quantity of the moving body 1 is large, the target position is made to be more easily reached. In contrast, when the deviation is small, by reducing the number of input values, the amount of calculation is reduced, and a calculation load can be thus reduced. In this manner, by making the number of input values variable depending on the degree of deviation between the current state quantity and the target state quantity, smooth path generation and reduction of a calculation load in the moving body 1 can be implemented.

Here, description returns back to the flowchart of FIG. 6. After the state quantity of each particle is predicted in Step S105, in the predicted state evaluation unit 240, an observation value is calculated from the updated state quantity of each particle (Step S106). An observation variable is defined based on the target state quantity calculated in the target state calculation unit 220. In the present embodiment, reaching the target lateral position being a position in a direction perpendicular to the target azimuth direction at the target position, maintaining the target speed, reaching the target azimuth, and keeping a safe distance from the moving obstruction are objectives. Based on these objectives, an observation value P_{y} is expressed by the following Expression (18), where a deviation Lₑ between the particle and the target lateral position Y_{L}, speed state quantity Vₚ of the particle, azimuth state quantity Θₚ of the particle, and an entering distance Dₚ to the danger region D are observation variables.

$$\\ \begin{matrix}[ Expression 18 ] & \\ {P}_{y} = \begin{matrix}[ {L}_{e} & {V}_{p} & {Θ}_{p} & {{D}_{p} ]}^{T}\end{matrix} & ( 18 )\end{matrix}$$

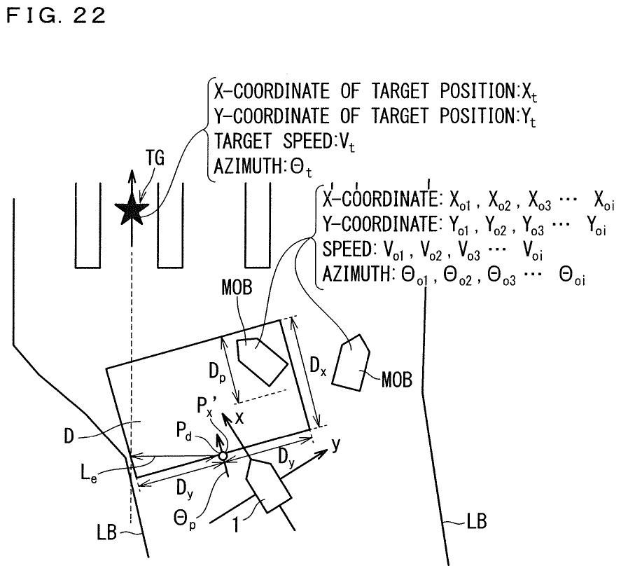

FIG. 22 is a diagram illustrating each of the observation variables. FIG. 22 schematically illustrates a particle Pa including the predicted state quantity Pₓ′ in the time T_{d} with respect to the current moving body 1. Based on the position and the azimuth of the particle Pa, the danger region D is set, and the moving obstruction MOB enters the danger region D. The entering distance Dₚ of the moving obstruction MOB to the danger region D is defined by a distance in a direction parallel to the azimuth Θₚ of the particle P_{d}.

Here, the danger region D is a rectangular region with a direction of long sides being inclined in the direction of the azimuth Θₚ of the particle P_{d}, and the region is a region having a length of a distance Dₓ ahead of the particle P_{d} and a length of a distance D_{y} in the right and left. Here, the distance Dₓ is expressed by the following Expression (19), using the speed Vₚ of the particle P_{d} and safety expected time Tₛ set in advance.

$$\begin{matrix}[ Expression 19 ] & \\ {D}_{x} = V \cdot {T}_{s} & ( 19 )\end{matrix}$$

Further, the distance D_{y} is expressed by the following Expression (20), using a parameter T_{sy} set in advance.

$$\begin{matrix}[ Expression 20 ] & \\ {D}_{y} = V \cdot {T}_{sy} & ( 20 )\end{matrix}$$

After the observation value of each particle is calculated in Step $106, in the predicted state evaluation unit 240, the weight W of each particle is updated from a difference between the observation value P_{y} of each particle and an ideal observation value P_{yi} (Step S107). Here, the ideal observation value P_{yi} is an observation value for the moving body 1 in virtually set target state quantity, and when the moving body 1 satisfies the target state quantity, the moving body 1 is in an ideal state. In the present embodiment, the ideal observation value P_{yi} includes a deviation Lₑₙₒₘ from a target sideways deviation, a target vehicle speed Vₙₒₘ, a target azimuth Θₜₙₒₘ, and a target entering distance Dₙₒₘ, based on the target state quantity, and is expressed by the following Expression (21).

$$\begin{matrix}[ Expression 21 ] & \\ {P}_{yi} = \begin{matrix}[ {L}_{e n o m} & {V}_{nom} & {Θ}_{tnom} & {{D}_{n o m} ]}^{T}\end{matrix} & ( 21 )\end{matrix}$$

Further, when the position of the particle is outside of the travelable region TA calculated in Step S102, the weight of each particle is set to 0, or is set to a value lower than the particles inside of the travelable region TA. For example, determination regarding outside or inside of the travelable region TA is performed by determining whether or not there are two-dimensional positions Xₚ and Yₚ of the particle in a polygonal region connecting each vertex of the travelable region TA and the moving body 1.

Here, in the description above, the particles outside of the travelable region TA have weights of 0. However, regarding the particles outside of the travelable region TA, the weights to be assigned to the particles may be variable, depending on a degree of deviation from the travelable region TA.

FIG. 23 is a conceptual diagram of processing of making the weights to be assigned to the particles outside of the travelable region TA variable. In FIG. 23, particles PW₄ inside of the travelable region TA ahead of the moving body 1 are assigned a weight W₄, and the travelable region TA may be referred to as a weight W₄-assigned region RW₄.

Further, on an outside of the weight W₄-assigned region RW₄, a weight W₃-assigned region RW₃ is set, and a particle PW₃ present therein is assigned a weight W₃. Further, on a further outside of the weight W₃-assigned region RW₃, a weight W₂-assigned region RW₂ is set, and if a particle is present therein, the particle is assigned a weight W₂. Further, on a further outside of the weight W₂-assigned region RW₂, a weight W₁-assigned region RW₁ is set, and a particle PW₁ present therein is assigned a weight W₁. Note that, regarding the weight, W₄ is the heaviest, and the weight is lighter in order of the weights W₃, W₂, and W₁.

In this manner, by performing evaluation of the predicted state quantity depending on the distance from the travelable region TA without removing the particles (prediction points) outside of the travelable region TA, path candidates can remain also in a region that is recognized as outside of the travelable region TA by the external sensors despite being the travelable region TA in actuality due to a limit of a recognizable range of external sensors or the like, and for the remaining path candidates, evaluation of the prediction points can be performed depending on the distance from the travelable region TA, that is, reliability, which makes path planning more easily succeed. Further, by assigning lighter weights to particles farther from the travelable region TA, it can be made less likely that a path is generated based on the particles, and safety of the generated path can be enhanced.

Further, in FIG. 23, the weights assigned to the particles are discontinuous values. However, the weights to be assigned may be values that continuously change depending on the distance from the travelable region TA.

Further, regarding the particles in the travelable region TA, the weights to be assigned to the particles may be variable, depending on the distance from a boundary defining the travelable region TA.

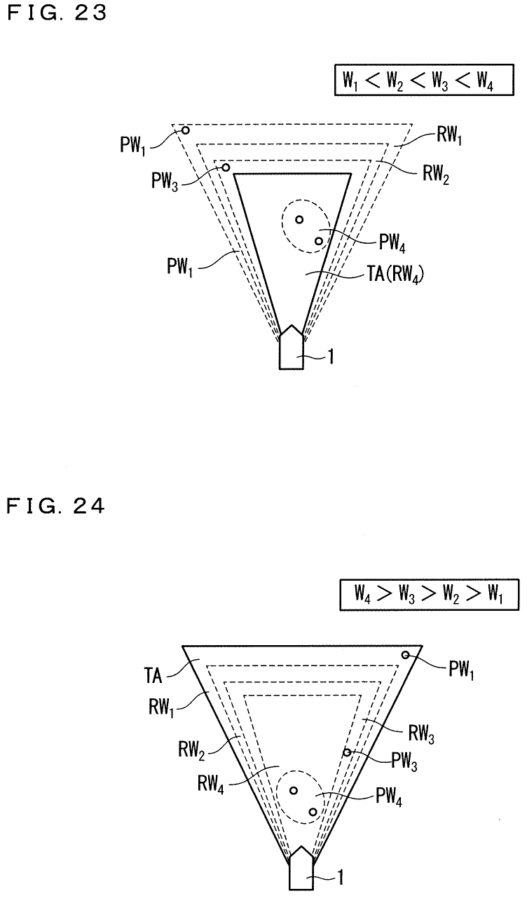

FIG. 24 is a conceptual diagram of processing of making the weights to be assigned to the particles inside of the travelable region TA variable. In FIG. 24, in the travelable region TA ahead of the moving body 1, the weight W₁-assigned region RW₁, the weight W₂-assigned region RW₂, the weight W₃-assigned region RW₃, and the weight W₄-assigned region RW₄ are set in order from the side of the boundary defining the travelable region TA toward the inner side. Processing in each assigned region is the same as the processing described with reference to FIG. 23, and regarding the weight, W₄ is the heaviest, and the weight is lighter in order of the weights W₃, W₂, and W₁.

In this manner, by performing assignment of the weights that become smaller as the regions are closer to the boundary defining the travelable region TA in the predicted state quantity inside of the travelable region TA, the weights of the predicted state quantity located at the center of the travelable region TA are greater than those near the boundary of the travelable region TA, and path planning that avoids the boundary of the travelable region TA to the extent possible can be performed, and safety of the generated path can be enhanced.

Further, in FIG. 24, the weights assigned to the particles are discontinuous values. However, the weights to be assigned may be values that continuously change depending on the distance from the boundary defining the travelable region TA.

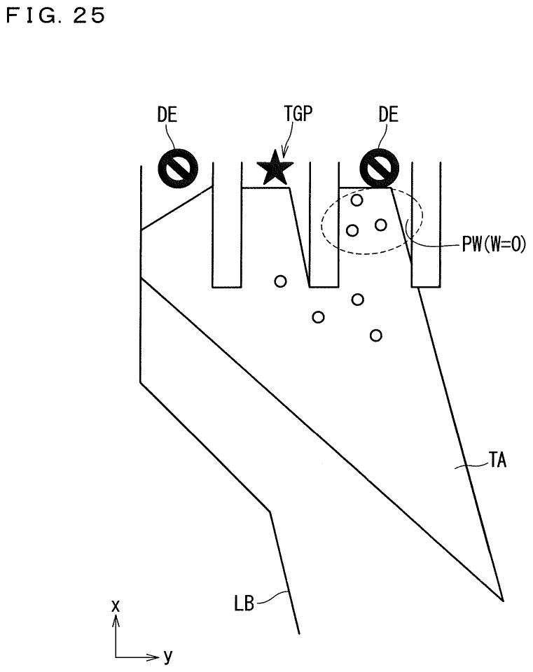

Further, regarding the particles inside of the travelable region TA, processing may be performed so as to assign weights of 0 or small weights to the particles that are predicted at a point that may be a dead end after traveling despite being present inside of the travelable region TA. FIG. 25 is a conceptual diagram illustrating the processing.

FIG. 25 illustrates a scene in which there is a narrow passage, such as an ETC gate, ahead of the moving body 1, and the target position TGP is present inside a passable gate. Other gates are untravelable and are dead ends DE, and are regions in which, after traveling, the moving body 1 cannot travel in the future. Particles PW predicted in the regions have a weight of 0 (W=0).

In this manner, this enables generation of a path for preventing from being surrounded by a dead end and being immovable before reaching the target position TGP, even inside the travelable region TA.

Note that, regarding determination as to whether it may be a dead end, for example, particles that have a small deviation in the x direction and have a large deviation in the y direction from the target position TGP in FIG. 25, that is, particles that are shifted from the target position TGP in the horizontal direction (y direction), are blocked by an obstruction in front of the target position. Thus, depending on whether or not the deviation in the x direction is small and the deviation in the y direction is large from the target position TGP, whether or not the particles are particles predicted at a point that may be a dead end can be determined.

Further, as described above with reference to FIG. 11, the particles predicted at a point that may be a dead end with the position of the dead end being excluded from the travelable region TA in advance may be regarded as being outside of the travelable region TA and may be assigned the weight W.

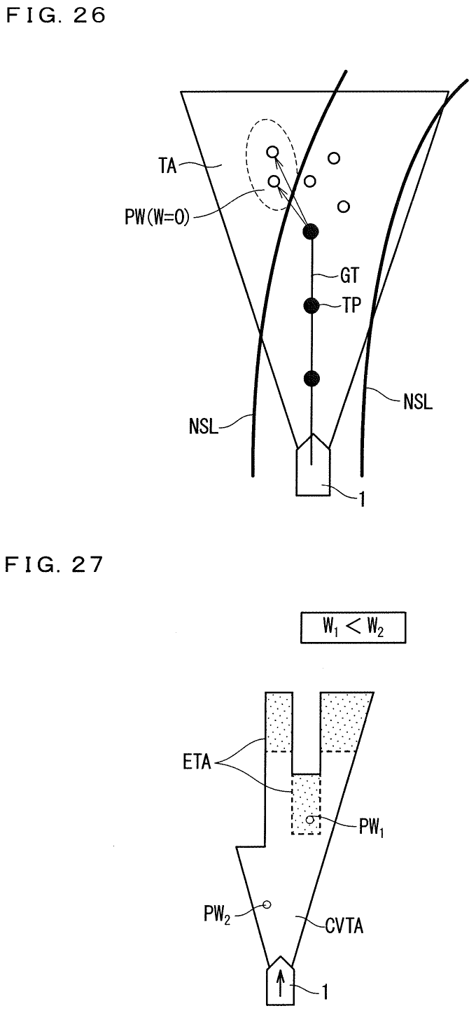

Further, regarding the particles inside of the travelable region, when there is a cross-over prohibiting line inside of the travelable region, and when the particles calculated in Step S105 are present at the path point generated in the path point calculation unit 250 one step before or the position to cross the cross-over prohibiting line for the moving body 1, the particles may be assigned the weight W of 0 or may be assigned a small weight. FIG. 26 is a conceptual diagram illustrating the processing.

FIG. 26 illustrates a scene in which the cross-over prohibiting lines NSL are provided on right and left sides of the moving body 1 in the traveling direction, and the generated path GT including a plurality of path points TP in the traveling traffic lane defined by the right and left cross-over prohibiting lines NSL is set. At the current time, some of the particles being evaluated in the predicted state evaluation unit 240 are the particles PW that are predicted at the position to cross the cross-over prohibiting lines NSL with respect to the path point TP generated in the path point calculation unit 250 one step before, and have the weight of 0 (W=0).

In this manner, by setting the weight of 0 to the particles predicted at the position to cross the cross-over prohibiting lines NSL with respect to the path point TP, a path can be prevented from being set in a region in which the moving body 1 cannot travel in the future, and safety of the generated path can be enhanced.

Further, as described above with reference to FIG. 13, the region surrounded by the travelable region TA and the cross-over prohibiting lines NSL may be excluded from the travelable region TA as the excluded region AR, and the particles predicted at the point may be regarded as being outside of the travelable region TA and may be assigned the weight W.

Further, regarding the particles outside of the travelable region that can be recognized at the current time, when there is a predicted travelable region, and when the particles are located in the predicted travelable region, processing may be performed so as not to set the weight W of the particles to 0, and the weight smaller than the weight of the particles inside of the travelable region that can be recognized at the current time may be assigned. FIG. 27 is a conceptual diagram illustrating weighting processing for the particles inside of the predicted travelable region.

In FIG. 27, the predicted travelable region ETA is provided ahead of the travelable region TA that can be recognized at the current time, and the particle PW₁ present inside of the predicted travelable region ETA is assigned the weight W₁. Further, the particle PW₂ present inside of the travelable region TA is assigned the weight W₂. Here, the weight W₁ is smaller than the weight W₂ (W₁<W₂).

By using the predicted travelable region ETA, a path can be generated up to position farther than the travelable region TA that can be recognized at the current time by the external sensors. Further, because reliability of the predicted travelable region ETA is not high, by relatively increasing the weight of the predicted state quantity inside of the travelable region TA that can be recognized at the current time by the external sensors, a path with high reliability can be generated.

Here, regarding the particles for predicting the state quantity in the discrete time length T_{d} in Step S105, with use of the predicted path of the moving obstruction obtained from the surrounding environment acquisition unit 130, determination is performed as to whether or not there is a predicted obstruction obtained using the predicted path at simultaneous time, that is, the same time as the time of predicting the particles, in a region around each of the particles, and when the predicted obstruction is present, processing of setting the weight W of the particles to 0 may be performed.

The weight W before update of each particle is defined again as Wₚ. The weight W is proportional to the weight before update and likelihood LLV, and is updated so that an integrated value of the weights of all of the particles is 1, using the following Expression (22).

$$\begin{matrix}[ Expression 22 ] & \\ \begin{matrix}{W}_{n} = \frac{{W}_{pn} \cdot LL {V}_{n}}{{\sum }_{m = 1}^{N p} {W}_{p m} \cdot LL {V}_{m}} & ( n = 1 … {N}_{p} )\end{matrix} & ( 22 )\end{matrix}$$

Here, the likelihood LLV is calculated using the following Expression (23), using a covariance matrix Q related to the state quantity Pₓ of the particle set in advance and a covariance matrix R related to the observation value P_{y}.

$$\begin{matrix}[ Expression 23 ] & \\ L L V = \frac{1}{{( \sqrt{2 π} )}^{2} \sqrt{\vert \prod \vert}} \cdot exp ( - \frac{1}{2} {( {P}_{y i} - {P}_{y} )}^{T} {\prod }^{- 1} ( {P}_{yi} - {P}_{y} ) ) & ( 23 )\end{matrix}$$

Here, a matrix Π is expressed by the following Expression (24).

$$\begin{matrix}[ Expression 24 ] & \\ \prod = {HQH}^{T} + R & ( 24 )\end{matrix}$$

Note that, when Pₓ=Pₓₙ, a value Hₙ of a measurement matrix H in the n-th particle is a value obtained by differentiating a measurement function h with the state quantity Pₓ, and is expressed by the following Expression (25).

$$\begin{matrix}[ Expression 25 ] & \\ {P}_{x} = h ( {P}_{y} ) & ( 25 )\end{matrix}$$

Further, the measurement function h is a function for calculating the observation value P_{y} from the state quantity Pₓ, and is expressed by the following Expression (26).

$$\begin{matrix}[ Expression 26 ] & \\ {H}_{n} = \frac{\partial h}{\partial {P}_{x}} {\vert}_{{P}_{x} = {P}_{x n}} & ( 26 )\end{matrix}$$

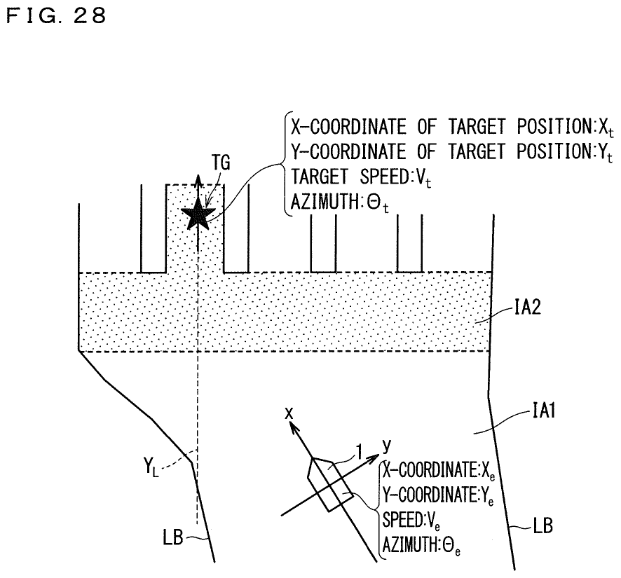

Regarding weight update of each particle based on a difference between the observation value of each particle and the ideal observation value, an evaluation weight as to which item is to be evaluated in what degree may be set, based on a difference between the moving body 1 and the target state quantity or an application scene. FIG. 28 is a conceptual diagram illustrating processing of setting of the evaluation weight.

In FIG. 28, the moving body 1 is away from the target lateral position Y_{L}, and in a region IA1 where it is important to reduce deviation from the target lateral position Y_{L}, the evaluation weight is set so that the likelihood of the particles having small deviation from the target lateral position Y_{L} at the time of weight update is increased.

By performing such setting, for example, in a scene of passing through a toll booth gate, when the target position is a gate to pass through, in a scene in which passing in a direction perpendicular to the gate is necessary, by placing more importance on a difference from the target state quantity related to the position in the sideways direction than a difference from the target state quantity related to the position in a direction perpendicular thereto, the position in the sideways direction can be adapted before the position in the direction perpendicular thereto is adapted, and a path enabling early reaching to the position to allow entry in the direction perpendicular to the gate can be generated.

Further, in FIG. 28, there is a large deviation between the azimuth Θₑ of the moving body 1 and the target azimuth Θₜ in the target state quantity TG, and in a region IA2 where it is important to reduce the deviation from the target azimuth Θₜ, the evaluation weight is set so that the likelihood of the particles having small deviation from the target azimuth Θₜ at the time of weight update is increased. Regarding setting of the evaluation weight, a larger weighting coefficient is set as the particle has smaller deviation.

By performing such setting, for example, in a scene of passing through a toll booth gate, when the target position is a gate to pass through, by setting a low evaluation weight of the state quantity related to the azimuth at a point with a far distance from the target position and setting a large evaluation weight of the state quantity related to the azimuth at a point with a close distance therefrom, there is a high degree of freedom of the state quantity related to the azimuth of a path at the point far from the target position, and such a path to adapt the state quantity related to the azimuth as approaching closer to the target position can be generated.

Here, description returns back to the flowchart of FIG. 6. After the weight of each particle is updated in Step S107, in the predicted state evaluation unit 240, resampling of the particle is performed, based on the weight of each particle (Step S108). Note that, in order to prevent significant reduction of the number of particles, resampling is performed only when an effective number Neff of particles is equal to or more than a threshold Nthr, and otherwise, no processing is performed in this step.

Here, the effective number Neff of particles is expressed by the following Expression (27).

$$\begin{matrix}[ Expression 27 ] & \\ {N}_{eff} = \frac{1}{{\sum }_{n = 1}^{N p} {( {W}_{n} )}^{2}} & ( 27 )\end{matrix}$$

In resampling, similarly to regular particle filters, sampling is performed at even intervals from an empirical distribution function. When resampling is performed, based on the following Expression (28), the weights are reset on an assumption that the weights of the particles are equal.

$$\begin{matrix}[ Expression 28 ] & \\ W = 1 / N p & ( 28 )\end{matrix}$$

After resampling of the particles is performed in Step S108, in the path point calculation unit 250, regarding the position and the speed of the particles, a weighted average value is calculated in the path generation unit 260, based on the weights calculated in the predicted state evaluation unit 240, and the points subjected to the weighted average including at least position data and speed data are stored as path points in a memory (not illustrated) in the path generation unit 260, for example (Step S109).

Further, regarding the path points, based on the weights calculated in the predicted state evaluation unit 240, the particles having the largest weight, that is, the largest weighting coefficient, may be used as the path points.

Further, the path points may include not only the position data and the speed data, but also azimuth data, steering angle data, and the like.

Further, the path points may use only the points of the position data as the path points.

After the path points are stored in Step S109, whether the time T has reached a planning horizon Tthr is determined (Step S110). When the time is less than the planning horizon (in a case of No), processing of Step SS104 and the subsequent steps is repeated. When the time T is equal to or more than the planning horizon Tthr (in a case of Yes), a point sequence of the path points including the position data and the speed data at respective discrete times that are stored as the path points in the path generation unit 260 is output to the motion controller 300 as a generated path.

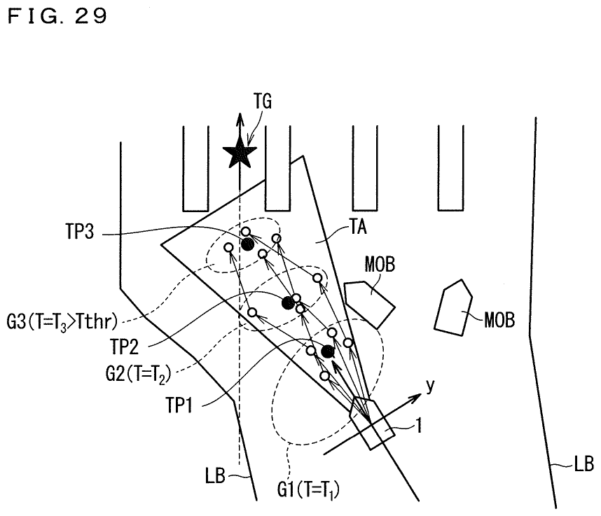

FIG. 29 illustrates a conceptual diagram of processing of obtaining a plurality of path points by repeating calculation from Step S104 to Step S110 until the time is equal to or more than the planning horizon Tthr. In FIG. 29, the number of particles is four, and the particles in the figure represent a state after resampling.

As illustrated in FIG. 29, inside of the travelable region TA, there are a particle group G1 at the time T=T₁, a particle group G2 at the time T=T₂, and a particle group G3 at the time T=T₃, and the time T=T₃ exceeds the planning horizon Tthr. The state quantities subjected to the weighted average of four particles respectively in the particle groups G1 to G3 are the path points TP1, TP2, and TP3. A point sequence of these path points becomes a generated path, and the path points with high likelihood based on evaluation of the predicted state evaluation unit 240 can be generated.

Further, by using the particles having the largest weight, that is, the largest weighting coefficient, in each of the particle groups G1 to G3 as the path points, effects similar to the above can be achieved.

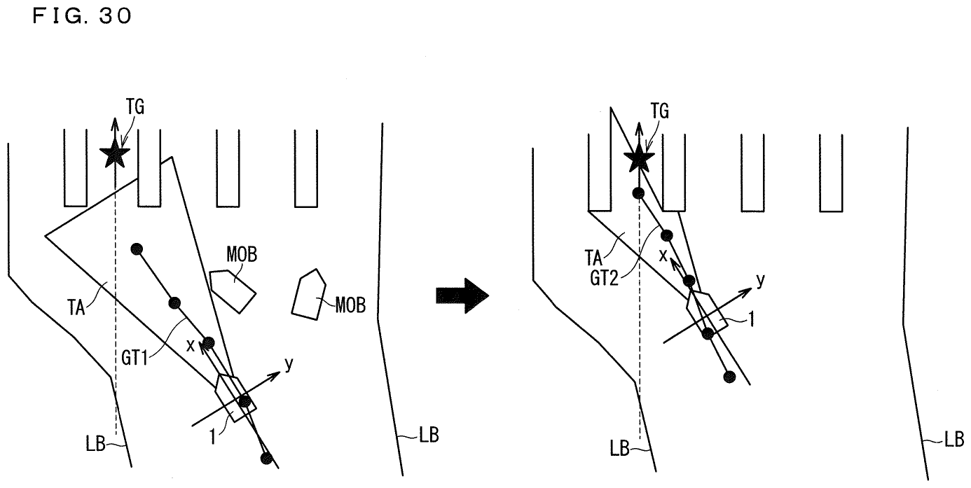

An example of path generation until reaching the target state quantity using the path planning apparatus 200 of the present embodiment described above will be described with reference to FIG. 30 and FIG. 31. FIG. 30 and FIG. 31 are schematic diagrams illustrating an example of path generation. A left figure of FIG. 30 schematically illustrates a generated path GT1 when the moving body 1 is present at a position far from the target state quantity TG. A right figure of FIG. 30 illustrates a generated path GT2 at a position slightly traveled forward from the case of the left figure subsequently to traveling forward along the generated path GT1 using the generated path GT1 of the left figure. A left figure of FIG. 31 illustrates a generated path GT3 at a position slightly traveled forward from the case of the right figure of FIG. 30 subsequently to traveling forward along the generated path GT1 using the generated path GT1 of the right figure of FIG. 30. A right figure of FIG. 31 illustrates a generated path GT4 after reaching the target state quantity TG subsequently to traveling forward along the generated path GT3 using the generated path GT3 of the left figure.

According to the path planning apparatus 200 of the first embodiment as described above, a path up to the target state quantity is evaluated based on the target state quantity including the state quantity of the position of the moving body 1 and the travelable region, and the path is generated based on evaluation results. Therefore, even when the travelable region is complicated, a destination can be reached through the travelable region.

### Second Embodiment

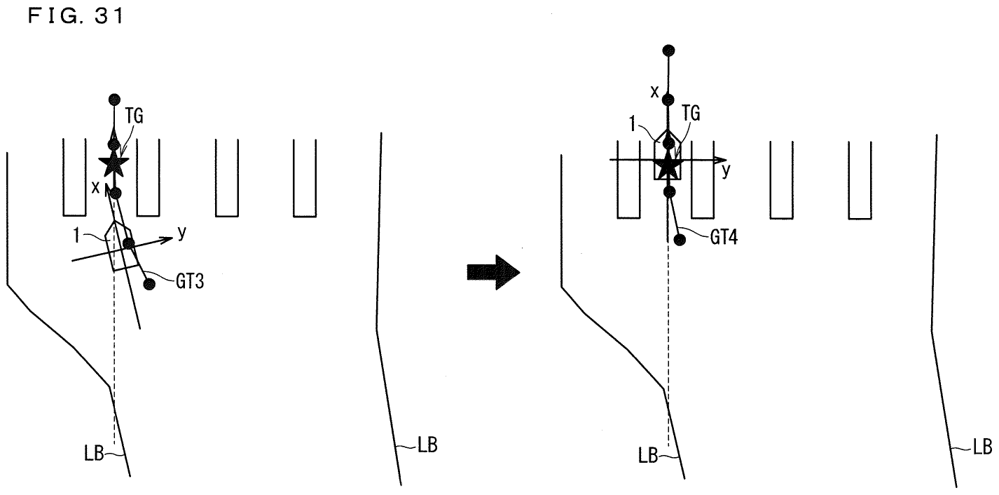

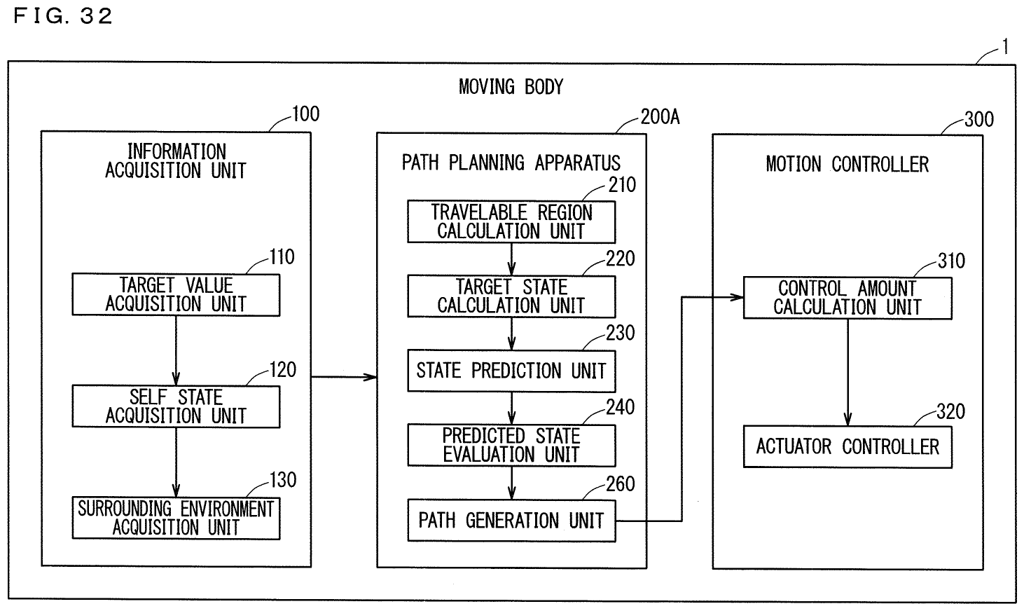

FIG. 32 is a block diagram illustrating an example of a schematic configuration of the moving body 1 equipped with a path planning apparatus according to a second embodiment. Note that, in FIG. 32, the same configurations as those of the moving body 1 described with reference to FIG. 1 are denoted by the same reference signs, and overlapping description will be omitted.

In the moving body 1 illustrated in FIG. 32, a configuration of a path planning apparatus 200A that generates a path to be traveled by the moving body 1 is different from the path planning apparatus 200 of the first embodiment. In other words, the path planning apparatus 200A of the second embodiment generates a path by calculating polynomials each passing through the current position and the target position of the moving body 1 in the state prediction unit 230, instead of using particle filters for state estimation, and is thus different from the path planning apparatus 200 in that the path planning apparatus 200A does not include the path point calculation unit 250.

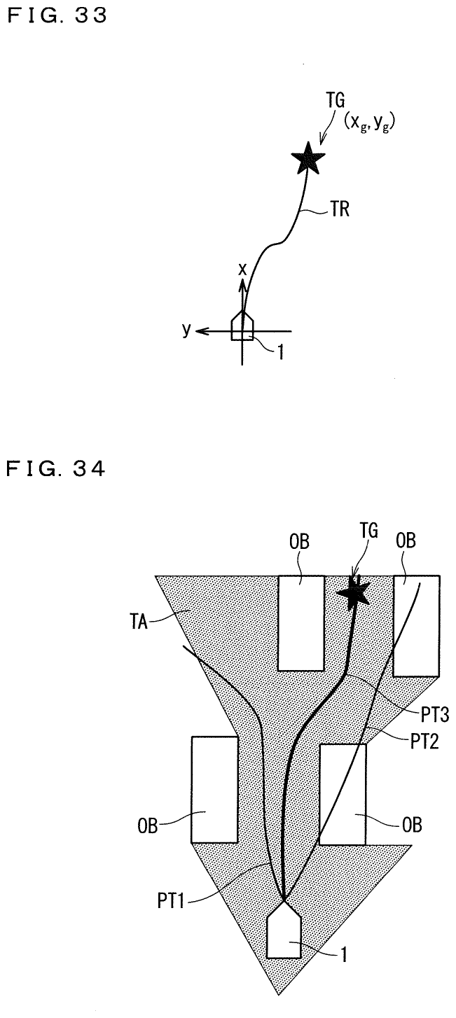

As a method of calculating polynomial paths connecting the moving body 1 and the target state quantity TG, the following description will be given based on an assumption that the target state quantity TG is a target position (x_{g}, y_{g}). FIG. 33 is a conceptual diagram illustrating a method of deriving a polynomial connecting the moving body 1 and the target position TG.

As in FIG. 33, when the position of the moving body 1 is the origin, the direction of the moving body 1 is the x-axis, and a direction perpendicular to the direction of the moving body is the y-axis, a polynomial y=f(x) connecting the moving body 1 and the target position TG is expressed by the following Expression (29).

$$\begin{matrix}[ Expression 29 ] & \\ y = f ( x ) = \sum {C}_{i} {x}^{i} & ( 29 )\end{matrix}$$

Further, the polynomial is subjected to a constraint condition that the polynomial must pass through the position (origin) and the target position TG of the moving body 1, and the direction must face the x-axis (the angle is 0 degrees) at the position point of the moving body 1 or must face a predetermined direction (angle) at the target position point.

Representing the above with a mathematical expression, by solving the following boundary condition, that is, simultaneous equations of conditions of a moving body position point and a target position point, each coefficient ci can be calculated. The simultaneous equations are expressed by the following Expressions (30) and (31). Here, x₀ is an x-coordinate value of the moving body position, and x_{g} is an x-coordinate value of the target position.

$$\begin{matrix}[ Expression 30 ] & \\ f ( {x}_{o} ) = {y}_{o} , f ( {x}_{g} ) = {y}_{g} & ( 30 )\end{matrix}$$

$$\begin{matrix}[ Expression 31 ] & \\ {{f ’ ( {x}_{o} ) = y ’}_{o} , f ’ ( {x}_{g} ) = y ’}_{g} & ( 31 )\end{matrix}$$

Next, a case in which the polynomial is expressed by the following Expression (32) will be described.

$$\begin{matrix}[ Expression 32 ] & \\ f ( x ) = {C}_{3} {x}^{3} + {C}_{2} {x}^{2} + {C}_{1} x + {C}_{o} & ( 32 )\end{matrix}$$

For example, given a boundary condition that a function value (f(x₀)) at the moving body position point is a y-coordinate value of the moving body 1, a function value (f′(x₀)) representing an inclination at the moving body position point is an azimuth of the moving body 1, and a function value (f″(x₀)) representing curvature at the moving body position point is 0, coefficients C₀, C₁, and C₂ are uniquely calculated, and by giving the remaining term of x³ at random, as many polynomial paths as the number of such random terms can be generated as illustrated in FIG. 34.

FIG. 34 illustrates, when there are a plurality of obstructions OB, three patterns of polynomial paths PT1, PT2, and PT3 for obtaining the polynomial paths connecting the moving body 1 and the target position TG avoiding the plurality of obstructions OB.

The polynomials for giving the polynomial paths PT1, PT2, and PT3 are respectively expressed by the following Expressions (33), (34), and (35).

$$\begin{matrix}[ Expression 33 ] & \\ {f ( x ) = C ’}_{3} {x}^{3} + {C}_{2} {x}^{2} + {C}_{1} x + {C}_{o} & ( 33 )\end{matrix}$$

$$\begin{matrix}[ Expression 34 ] & \\ {f ( x ) = C ”}_{3} {x}^{3} + {C}_{2} {x}^{2} + {C}_{1} x + {C}_{o} & ( 34 )\end{matrix}$$

$$\begin{matrix}[ Expression 35 ] & \\ {f ( x ) = C ’ ’ ’}_{3} {x}^{3} + {C}_{2} {x}^{2} + {C}_{1} x + {C}_{o} & ( 35 )\end{matrix}$$

From the plurality of polynomial paths, evaluation such as a reach value to the target position TG and whether the polynomial path is away from the boundary of the travelable region TA and is inside of the travelable region TA is performed, and the polynomial path having the highest evaluation is used as the generated path. In the example of FIG. 34, the polynomial path PT3 is the generated path.

Further, in a case in which the polynomial is expressed by above Expression (32), the polynomial paths can be obtained with the following method as well.

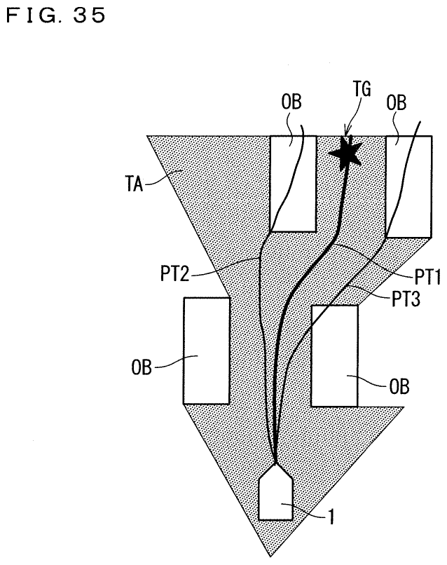

For example, given a boundary condition that the function value (f(x₀)) at the moving body position point is a y-coordinate value of the moving body 1, a function value (f′(x₀)) representing an inclination at the moving body position point is an azimuth of the moving body 1, a function value (f(x_{g})) at the moving body position point is a y-coordinate value of the target position TG, and a function value (f(x_{g})) at the moving body position point is an azimuth of the target position TG, coefficients C₃, C₂, C₁, and C₀ can be uniquely calculated. By changing respective coefficients at random around values of the calculated coefficients C₃, C₂, C₁, and C₀, a plurality of polynomial paths can be generated as in FIG. 35.

FIG. 35 illustrates, when there are a plurality of obstructions OB, three patterns of polynomial paths PT1, PT2, and PT3 for obtaining the polynomial paths connecting the moving body 1 and the target position TG avoiding the plurality of obstructions OB.

The polynomials for giving the polynomial paths PT1, PT2, and PT3 are respectively expressed by the following Expressions (36), (37), and (38).

$$\begin{matrix}[ Expression 36 ] & \\ {{{{f ( x ) = C ’}_{3} {x}^{3} + C ’}_{2} {x}^{2} + C ’}_{1} x + C ’}_{o} & ( 36 )\end{matrix}$$

$$\begin{matrix}[ Expression 37 ] & \\ {{{{f ( x ) = C ”}_{3} {x}^{3} + C ”}_{2} {x}^{2} + C ”}_{1} x + C ”}_{o} & ( 37 )\end{matrix}$$

$$\begin{matrix}[ Expression 38 ] & \\ {{{{f ( x ) = C ’ ’ ’}_{3} {x}^{3} + C ’ ’ ’}_{2} {x}^{2} + C ’ ’ ’}_{1} x + C ’ ’ ’}_{o} & ( 38 )\end{matrix}$$

From the plurality of polynomial paths, evaluation such as a reach value to the target position TG and whether the polynomial path is away from the boundary of the travelable region TA and is inside of the travelable region TA is performed, and the polynomial path having the highest evaluation is used as the generated path. In the example of FIG. 35, the polynomial path PT1 is the generated path.

As described above, the path planning apparatus 200A of the second embodiment obtains the generated path by calculating polynomials each passing through the current position and the target position of the moving body 1, instead of using particle filters for state estimation, and thus does not calculate the path points and does not include the path point calculation unit 250.

Here, one advantage of a case of employing the method of obtaining the generated path by calculating polynomials is that there is a low calculation load. In other words, by merely solving the simultaneous equations described above, one candidate path can be calculated. However, when particle filters are used, calculation needs to be repeated for the length of the path in which state transitions of a large number of particles are to be generated, and thus there is a large calculation load.

In contrast, one advantage of a case of employing the method of obtaining the generated path by using particle filters is that a path that ensures being inside of the travelable region TA can be generated. In other words, the particle filters are a method of calculating one path point by using a large number of prediction points (predicted state quantities), and from a positional relationship between the point of each particle and the travelable region TA, evaluation as to whether the path point is outside or inside of the travelable region TA can be performed. Therefore, a path that ensures being inside of the travelable region TA can be generated. In contrast, in the method of obtaining the generated path by calculating polynomials, a path connecting the moving body 1 and the target position TG can be generated, but “being inside of the travelable region TA” and “avoiding an obstruction” cannot be included in a mathematical expression of the polynomials or cannot be considered, and thus the generated path may be outside of the travelable region TA.

Further, one advantage of a case of employing the method of obtaining the generated path by using particle filters is that a search range of a path is wide. In other words, in the method of obtaining the generated path by calculating polynomials, only a path that can be expressed by a polynomial can be obtained and thus the search range is small. However, when the particle filters are used, prediction points of the state is used as a base, that is, points are used for expression, and thus the search range is wide. Further, a non-linear path can also be obtained, and a path that cannot be expressed by a polynomial can be generated as well.

### <Modification of Weighting>

The predicted state evaluation unit 240 of the first embodiment described above assigns a weight to each predicted state quantity, that is, each particle, and obtains weighted path candidates. In this case, when the predicted state quantity is greatly deviated from the current state quantity of the moving body 1 or is greatly deviated from the state quantity of the path point previously calculated, and a path is generated using the path point calculated based on such predicted state quantity, the path may suddenly change and cause the ride of the moving body 1 to be uncomfortable.

In view of this, in the predicted state evaluation unit 240, when the predicted state quantity is greatly deviated from the current state quantity of the moving body 1 and is greatly deviated from the state quantity of the path point previously calculated, the weighting coefficient can be reduced, so that such a suddenly changing path can be prevented from being generated and the ride of the moving body 1 can be improved to be comfortable.

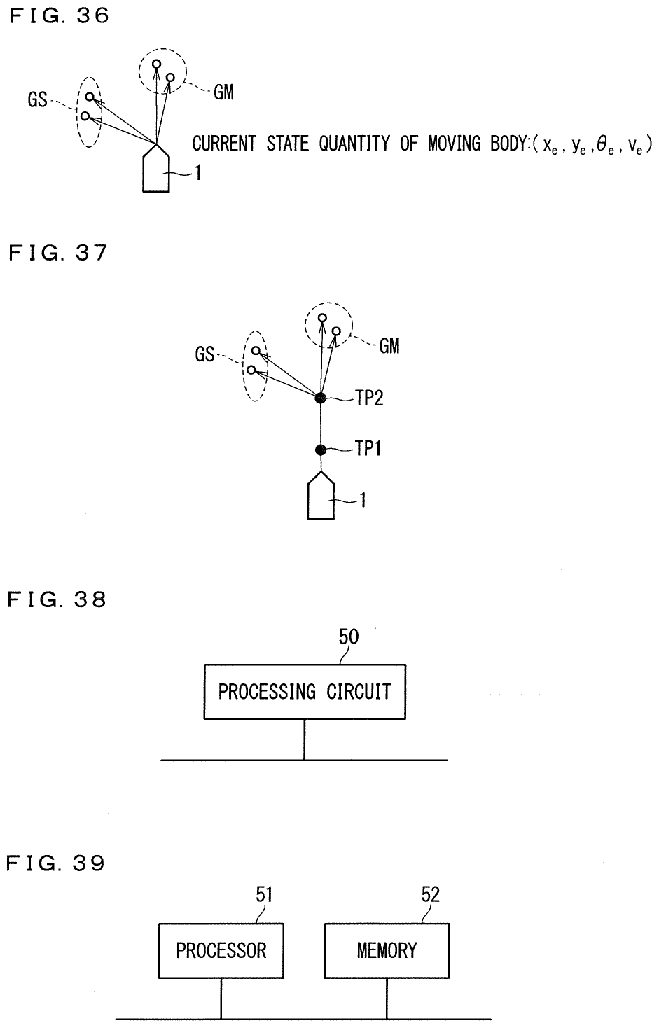

FIG. 36 illustrates a conceptual diagram of weighting when the predicted state quantity is greatly deviated from the current state quantity of the moving body 1. As illustrated in FIG. 36, when there are a particle group GS greatly deviated from the current state quantity (xₑ, yₑ, θₑ, Vₑ) of the moving body 1 and a particle group GM not so greatly deviated from the current state quantity of the moving body 1, the predicted state evaluation unit 240 reduces the weighting coefficient of the particles of the particle group GS. In contrast, the predicted state evaluation unit 240 does not reduce the weighting coefficient of the particles of the particle group GM.

Here, regarding a degree of deviation between the current state quantity and the predicted state quantity (particles) of the moving body 1, the difference between both of the state quantities can be determined based on a threshold determined in advance. When the difference is larger than the threshold, it can be determined that the deviation is large, whereas when the difference is equal to or less than the threshold, it can be determined that the deviation is small.

Further, regarding weighting for the particles, the weighting coefficients may be changed based on an absolute value of a difference between the current state quantity and the predicted state quantity (particles) of the moving body 1. For example, such weighting coefficients that gradually change may be set in advance based on an absolute value of a difference between both of the state quantities. When the difference between both of the state quantities becomes larger, the weighting coefficients may be gradually reduced, whereas when the difference between both of the state quantities becomes larger, the weighting coefficients may be gradually increased.

FIG. 37 illustrates a conceptual diagram of weighting when the predicted state quantity is greatly deviated from the state quantity of the path point previously calculated. As illustrated in FIG. 37, when there are a particle group GS greatly deviated from the state quantity of the path point TP2 previously calculated and a particle group GM not so greatly deviated from the state quantity of the path point TP2 previously calculated, the predicted state evaluation unit 240 reduces the weighting coefficient of the particles of the particle group GS. In contrast, the predicted state evaluation unit 240 does not reduce the weighting coefficient of the particles of the particle group GM.

Here, regarding a degree of deviation between the state quantity of the path point TP2 previously calculated and the predicted state quantity (particles), the difference between both of the state quantities can be determined based on a threshold determined in advance. When the difference is larger than the threshold, it can be determined that the deviation is large, whereas when the difference is equal to or less than the threshold, it can be determined that the deviation is small.

Further, regarding weighting for the particles, the weighting coefficients may be changed based on an absolute value of a difference between the state quantity of the path point TP2 previously calculated and the predicted state quantity (particles). For example, such weighting coefficients that gradually change may be set in advance based on an absolute value of a difference between both of the state quantities. When the difference between both of the state quantities becomes larger, the weighting coefficients may be gradually reduced, whereas when the difference between both of the state quantities becomes larger, the weighting coefficients may be gradually increased.

Note that each constituent element of the path planning apparatuses 200 and 200A according to the first and second embodiments described above can be configured using a computer, and is implemented when the computer executes a program. In other words, the path planning apparatuses 200 and 200A are implemented by a processing circuit 50 illustrated in FIG. 38, for example. A processor such as a CPU or a digital signal processor (DSP) is applied to the processing circuit 50, and a function of each unit is implemented when the program stored in a storage apparatus is executed.

Note that dedicated hardware may be applied to the processing circuit 50. When the processing circuit 50 is dedicated hardware, the processing circuit 50 is, for example, a single circuit, a composite circuit, a programmed processor, a parallel programmed processor, an application specific integrated circuit (ASIC), field-programmable gate array (FPGA), a combination of these, or the like.

In the path planning apparatuses 200 and 200A, functions of respective constituent elements may be implemented in individual processing circuits, or those functions may be collectively implemented in one processing circuit.

Further, FIG. 39 illustrates a hardware configuration when the processing circuit 50 is configured using a processor. In this case, a function of each unit of the path planning apparatuses 200 and 200A is implemented by a combination with software or the like (software, firmware, or software and firmware). The software or the like is described as a program and is stored in a memory 52. A processor 51 functioning as the processing circuit 50 reads and executes the program stored in the memory 52 (storage apparatus), and thereby implements the function of each unit. In other words, it can be said that the program causes the computer to execute procedures and methods of operations of the constituent elements of the path planning apparatuses 200 and 200A.

Here, the memory 52 may be, for example, a non-volatile or volatile semiconductor memory such as a RAM, a ROM, a flash memory, an erasable programmable read only memory (EPROM), and an electrically erasable programmable read only memory (EEPROM), a hard disk drive (HDD), a magnetic disk, a flexible disk, an optical disc, a compact disc, a MiniDisc, a Digital Versatile Disc (DVD) and a driving apparatus or the like therefor, or any storage medium to be used in future.

A configuration in which the functions of the constituent elements of the path planning apparatuses 200 and 200A are implemented by one of hardware and software or the like is described above. However, this is not restrictive, and a part of the constituent elements of the path planning apparatuses 200 and 200A may be implemented by dedicated hardware, and another part of the constituent elements may be implemented by software or the like. For example, functions of a part of the constituent elements may be implemented by the processing circuit 50 as dedicated hardware, and functions of another part of the constituent elements may be implemented by the processing circuit 50 as the processor 51 reading and executing the program stored in the memory 52.

As described above, the path planning apparatuses 200 and 200A can implement each of the functions described above, using hardware, software or the like, or a combination of these.

While the present disclosure has been described in detail, the foregoing description is in all aspects illustrative and not restrictive. It is therefore understood that numerous unillustrated modifications can be devised without departing from the scope of the present disclosure.

Note that, in the present disclosure, each of the embodiments can be freely combined and each of the embodiments can be modified or omitted as appropriate within the scope of the disclosure.

1. A path planning apparatus configured to plan a path of a moving body, the path planning apparatus comprising:
travelable region calculation circuitry configured to calculate a travelable region of the moving body, based on surrounding information of the moving body;
target state calculation circuitry configured to calculate target state quantity including at least a target position of the moving body;
state prediction circuitry configured to predict at least current state quantity of the moving body and state quantity of the moving body at one or more positions between a current position and the target position of the moving body, and thereby generate one or more path candidates;
predicted state evaluation circuitry configured to evaluate the one or more path candidates based on the target state quantity and the travelable region, and output evaluation results; and
path generation circuitry configured to generate the path from the one or more path candidates based on the evaluation results, and output the path to a motion controller configured to control the moving body based on the path.

2. The path planning apparatus according to claim 1, further comprising
path point calculation circuitry configured to calculate a path point from the one or more path candidates, based on the evaluation results, wherein
the path generation circuitry generates a point sequence including the path point as the path.

3. The path planning apparatus according to claim 1, wherein
the travelable region calculation circuitry predicts a future travelable region of a current travelable region based on time series variation of a shape of a past travelable region calculated earlier than current time, uses the future travelable region as a predicted travelable region, combines the current travelable region and the predicted travelable region together, and thereby extends the travelable region.

4. The path planning apparatus according to claim 1, wherein
the travelable region calculation circuitry predicts a future travelable region of a current travelable region based on a type of an obstruction outside of a past travelable region calculated earlier than current time, uses the future travelable region as a predicted travelable region, combines the current travelable region and the predicted travelable region together, and thereby extends the travelable region.

5. The path planning apparatus according to claim 4, wherein
when the obstruction outside of the past travelable region is a stationary obstruction, the travelable region calculation circuitry determines that a region ahead of the stationary obstruction remains being an untravelable region even in future, and when the obstruction outside of the past travelable region is a moving obstruction, in the future, the travelable region calculation circuitry extends the travelable region based on a moving direction and a moving speed of the moving obstruction, and extends the travelable region based on a speed of the moving body in a region without the obstruction outside of the past travelable region.

6. The path planning apparatus according to claim 1, wherein
the travelable region calculation circuitry predicts a region in which the moving body cannot travel in future based on surrounding environment information, and excludes the region to obtain the travelable region.

7. The path planning apparatus according to claim 1, wherein
the target state calculation circuitry includes a target speed of the moving body in the target state quantity.

8. The path planning apparatus according to claim 7, wherein
the target state calculation circuitry includes a target azimuth of the moving body in the target state quantity.

9. The path planning apparatus according to claim 8, wherein
the target state calculation circuitry includes a target lateral position in the target state quantity, the target lateral position being a position in a direction perpendicular to a direction of the target azimuth.

10. The path planning apparatus according to claim 1, wherein
when the target position is present outside of the travelable region, the target state calculation circuitry resets a position closest to the target position in the travelable region as the target position.

11. The path planning apparatus according to claim 7, wherein
the target state calculation circuitry sets an upper limit value to the target speed, depending on a shape of the travelable region.

12. The path planning apparatus according to claim 1, wherein
the state prediction circuitry sets an upper limit value depending on a shape of the travelable region to one or more input values, inputs the one or more input values to a motion model of the moving body, and thereby calculates the one or more path candidates.

13. The path planning apparatus according to claim 12, wherein
the state prediction circuitry changes a distribution of the one or more input values depending on the shape of the travelable region for the one or more input values, inputs the one or more input values to the motion model of the moving body, and thereby calculates the one or more path candidates.

14. The path planning apparatus according to claim 12, wherein
the state prediction circuitry changes number of the one or more input values, depending on the shape of the travelable region.

15. The path planning apparatus according to claim 1, wherein
the state prediction circuitry changes a distribution of one or more input values depending on a degree of deviation between the target state quantity and the current state quantity of the moving body for the one or more input values, inputs the one or more input values to a motion model of the moving body, and thereby calculates the one or more path candidates.

16. The path planning apparatus according to claim 15, wherein
the state prediction circuitry changes number of the one or more input values, depending on the degree of deviation.

17. The path planning apparatus according to claim 1, wherein
the predicted state evaluation circuitry sets a weighting coefficient to a deviation between the target state quantity and the current state quantity of the moving body, and thereby evaluates the one or more path candidates.

18. The path planning apparatus according to claim 8, wherein
the predicted state evaluation circuitry sets weighting to a deviation between the target state quantity and the current state quantity of the moving body, changes a weighting coefficient for an azimuth of the moving body depending on a deviation between the azimuth and the target azimuth of the moving body, and thereby evaluates the one or more path candidates.

19. The path planning apparatus according to claim 1, wherein
the predicted state evaluation circuitry sets weighting to the one or more path candidates to obtain one or more weighted path candidates, and thereby evaluates the one or more path candidates, based on a weight of the one or more weighted path candidates.

20. The path planning apparatus according to claim 19, wherein
the predicted state evaluation circuitry sets a weighting coefficient of 0 to the one or more path candidates present outside of the travelable region to obtain the one or more weighted path candidates.

21.-28. (canceled)
